(19) United States
(12) Patent Application Publication
(10) Pub. No.: US 2026/0222826 A1
(43) Pub. Date: Jul. 30, 2026

(54) MULTI-ACCESS O-RAN FOR ENTERPRISE

(71) Applicant: NOKIA SOLUTIONS AND NETWORKS OY, Espoo (FI)

(72) Inventors: Ahan KAK, Summit, NJ (US); Quan Pham VAN, New Providence, NJ (US); Huu Trung THIEU, Paris (FR); Nak Jung CHOI, Florham Park, NJ (US)

(21) Appl. No.: 18/846,803

(22) PCT Filed: Mar. 14, 2022
(86) PCT No.: PCT/US2022/020116

§ 371 Date: Sep. 13, 2024

(51) Int. Cl. H04W 24/02

(52) U.S. Cl. CPC H04W 24/02

(57) ABSTRACT

There is a first node handling CP operations in an ORAN, a second node handling near-real-time control operations in the ORAN, a third node providing WLAN termination for AP(s), and a fourth node providing SMO in the ORAN. The first and second node can be configured (e.g., by the fourth node) in multiple multiple-access modes for multi-access operation, which changes from which node or both nodes control operations are provided in the ORAN. Control interfaces may be changed too. The third node may register with the second node and may report AP(s) discovered and accessible by the third node. The first, second, and third nodes can participate in AP handovers between original and other third nodes.

### TECHNICAL FIELD

Exemplary embodiments herein relate generally to wireless communications in radio access networks (RANs) and, more specifically, relates to improvements in Open Radio Access Network (ORAN) or similar RANs, e.g., for better integration of Wireless Local Area Network (WLAN) integration and discovery.

### BACKGROUND

For a cellular system, the system was originally based on RANs (radio access networks) that were typically one physical device or contained within one physical device. The RANs provided access for UEs (user equipment, a wireless and typically mobile device) to the cellular network, which itself could be connected to other networks such as the Internet. Typical RANs include an eNB, which includes a base station under Long-Term Evolution (LTE), and a gNB, which includes a base station under fifth generation (5G). The base stations provide access by UEs to the network.

A trend recently is to split RANs into two functional components, a Distributed Unit (DU) and Central Unit (CU). The CU can be further decoupled into distinct control plane (CU-CP) and user plane (CU-UP) functions. Replacing the monolithic RAN with the CU/DU allows for new deployment models that feature, e.g., centralized packet processing functions.

Recently, an O-RAN (Open Radio Access Network) has been proposed. The O-RAN architecture has been put forth by an O-RAN Alliance, and this architecture has paved the way for disaggregated RANs coupled with a robust control architecture relying on software. While the NG-RAN (Next Generation-Radio Access Network) architecture pioneered the disaggregation of the monolithic RAN into a CU-CP, CU-UP, and DU, O-RAN further disaggregates the DU into two distinct entities—an O-RAN DU (O-DU) and an O-RAN radio unit (O-RU). Additionally, through the introduction of a near-real time controller and supporting applications, O-RAN has also given rise to the possibility of introducing network control functionalities and assurance frameworks that are geared specifically towards the access network.

While this is a beneficial architecture, this could be improved.

### BRIEF SUMMARY

This section is intended to include examples and is not intended to be limiting.

In an exemplary embodiment, a method is disclosed that includes sending, by a first node handling control plane operations in an open radio access network to a second node handling near-real-time control operations in the open radio access network, one or more messages comprising indication of control capabilities exposed at the first node within context of multi-access operation between the first node, second node, and a third node that provides wireless local area network termination for one or more access points. The method includes receiving, at the first node from the second node, an indication of one of multiple-access modes for multi-access operation. The method further includes configuring which control operations of the control capabilities are able to be provided by the first node based on the received indication.

An additional exemplary embodiment includes a computer program, comprising code for performing the method of the previous paragraph, when the computer program is run on a processor. The computer program according to this paragraph, wherein the computer program is a computer program product comprising a computer-readable medium bearing computer program code embodied therein for use with a computer. Another example is the computer program according to this paragraph, wherein the program is directly loadable into an internal memory of the computer.

An exemplary apparatus includes one or more processors and one or more memories including computer program code. The one or more memories and the computer program code are configured to, with the one or more processors, cause the apparatus at least to: send, by a first node handling control plane operations in an open radio access network to a second node handling near-real-time control operations in the open radio access network, one or more messages comprising indication of control capabilities exposed at the first node within context of multi-access operation between the first node, second node, and a third node that provides wireless local area network termination for one or more access points; receive, at the first node from the second node, an indication of one of multiple-access modes for multi-access operation; and configure which control operations of the control capabilities are able to be provided by the first node based on the received indication.

An exemplary computer program product includes a computer-readable storage medium bearing computer program code embodied therein for use with a computer. The computer program code includes: code for sending, by a first node handling control plane operations in an open radio access network to a second node handling near-real-time control operations in the open radio access network, one or more messages comprising indication of control capabilities exposed at the first node within context of multi-access operation between the first node, second node, and a third node that provides wireless local area network termination for one or more access points; code for receiving, at the first node from the second node, an indication of one of multiple-access modes for multi-access operation; and code for configuring which control operations of the control capabilities are able to be provided by the first node based on the received indication.

In another exemplary embodiment, an apparatus comprises means for performing: sending, by a first node handling control plane operations in an open radio access network to a second node handling near-real-time control operations in the open radio access network, one or more messages comprising indication of control capabilities exposed at the first node within context of multi-access operation between the first node, second node, and a third node that provides wireless local area network termination for one or more access points; receiving, at the first node from the second node, an indication of one of multiple-access modes for multi-access operation; and configuring which control operations of the control capabilities are able to be provided by the first node based on the received indication.

In an exemplary embodiment, a method is disclosed that includes, in an open radio access network having a first node handling control plane operations in the open radio access network, receiving at a second node one or more messages from the first node comprising indication of control capabilities exposed at the first node within context of multi-access operation between the first node, second node, and a third node that provides wireless local area network termination for one or more access points. The second node handles near-real-time control operations in the open radio access network. The method includes sending, from the second node to the first node, an indication of one of multiple-access modes for multi-access operation, and configuring and using control operations of the control capabilities that are able to be provided by the second node based on the sent indication.

An additional exemplary embodiment includes a computer program, comprising code for performing the method of the previous paragraph, when the computer program is run on a processor. The computer program according to this paragraph, wherein the computer program is a computer program product comprising a computer-readable medium bearing computer program code embodied therein for use with a computer. Another example is the computer program according to this paragraph, wherein the program is directly loadable into an internal memory of the computer.

An exemplary apparatus includes one or more processors and one or more memories including computer program code. The one or more memories and the computer program code are configured to, with the one or more processors, cause the apparatus at least to: in an open radio access network having a first node handling control plane operations in the open radio access network, receive at a second node one or more messages from the first node comprising indication of control capabilities exposed at the first node within context of multi-access operation between the first node, second node, and a third node that provides wireless local area network termination for one or more access points, the second node handling near-real-time control operations in the open radio access network; send, from the second node to the first node, an indication of one of multiple-access modes for multi-access operation; and configure and use control operations of the control capabilities that are able to be provided by the second node based on the sent indication.

An exemplary computer program product includes a computer-readable storage medium bearing computer program code embodied therein for use with a computer. The computer program code includes: code, in an open radio access network having a first node handling control plane operations in the open radio access network, for receiving at a second node one or more messages from the first node comprising indication of control capabilities exposed at the first node within context of multi-access operation between the first node, second node, and a third node that provides wireless local area network termination for one or more access points, the second node handling near-real-time control operations in the open radio access network; code for sending, from the second node to the first node, an indication of one of multiple-access modes for multi-access operation; and code for configuring and using control operations of the control capabilities that are able to be provided by the second node based on the sent indication.

In another exemplary embodiment, an apparatus comprises means for performing: in an open radio access network having a first node handling control plane operations in the open radio access network, receiving at a second node one or more messages from the first node comprising indication of control capabilities exposed at the first node within context of multi-access operation between the first node, second node, and a third node that provides wireless local area network termination for one or more access points, the second node handling near-real-time control operations in the open radio access network; sending, from the second node to the first node, an indication of one of multiple-access modes for multi-access operation; and configuring and using control operations of the control capabilities that are able to be provided by the second node based on the sent indication.

In an exemplary embodiment, a method is disclosed that includes, in an open radio access network having a first node handling control plane operations in the open radio access network, a second node handling near-real-time control operations in the open radio access network, and a third node that provides wireless local area network termination for one or more access points, determining at a fourth node a policy affecting control plane distribution to be used between the first and second nodes. The fourth node provides service management and orchestration in the open radio access network. The method includes sending, based on the policy, from the fourth node to the second node indication of control plane distribution to be used between the first and second nodes.

An additional exemplary embodiment includes a computer program, comprising code for performing the method of the previous paragraph, when the computer program is run on a processor. The computer program according to this paragraph, wherein the computer program is a computer program product comprising a computer-readable medium bearing computer program code embodied therein for use with a computer. Another example is the computer program according to this paragraph, wherein the program is directly loadable into an internal memory of the computer.

An exemplary apparatus includes one or more processors and one or more memories including computer program code. The one or more memories and the computer program code are configured to, with the one or more processors, cause the apparatus at least to: in an open radio access network having a first node handling control plane operations in the open radio access network, a second node handling near-real-time control operations in the open radio access network, and a third node that provides wireless local area network termination for one or more access points, determine at a fourth node a policy affecting control plane distribution to be used between the first and second nodes, wherein the fourth node provides service management and orchestration in the open radio access network; and send, based on the policy, from the fourth node to the second node indication of control plane distribution to be used between the first and second nodes.

An exemplary computer program product includes a computer-readable storage medium bearing computer program code embodied therein for use with a computer. The computer program code includes: code, in an open radio access network having a first node handling control plane operations in the open radio access network, a second node handling near-real-time control operations in the open radio access network, and a third node that provides wireless local area network termination for one or more access points, for determining at a fourth node a policy affecting control plane distribution to be used between the first and second nodes, wherein the fourth node provides service management and orchestration in the open radio access network; and code for sending, based on the policy, from the fourth node to the second node indication of control plane distribution to be used between the first and second nodes.

In another exemplary embodiment, an apparatus comprises means for performing: in an open radio access network having a first node handling control plane operations in the open radio access network, a second node handling near-real-time control operations in the open radio access network, and a third node that provides wireless local area network termination for one or more access points, determining at a fourth node a policy affecting control plane distribution to be used between the first and second nodes, wherein the fourth node provides service management and orchestration in the open radio access network; and sending, based on the policy, from the fourth node to the second node indication of control plane distribution to be used between the first and second nodes.

### BRIEF DESCRIPTION OF THE DRAWINGS

In the attached Drawing Figures:

FIG. 1 is a block diagram of an O-RAN reference architecture;

FIG. 2 is a block diagram of an example system architecture for multi-access operation, in accordance with an exemplary embodiment;

FIG. 2A is a block diagram of an apparatus that may be used for any of the entities in FIG. 2 (or any other figure herein);

FIG. 3, which include FIGS. 3A, 3B, and 3C, is a block diagram illustrating possible operational modes for the multi-access control framework, in accordance with exemplary embodiments;

FIG. 4 is a signaling flow diagram illustrating signaling for the programmable multi-access control plane distribution feature, in accordance with an exemplary embodiment;

FIG. 5 is a signaling flow diagram for a near-RT RIC Assisted NG-WT discovery procedure, in accordance with an exemplary embodiment;

FIG. 6 illustrates an Inter-NG-WT mobility scenario, in accordance with an exemplary embodiment;

FIG. 7 is a signaling flow diagram illustrating signaling for legacy inter-NG-WT handover, in accordance with an exemplary embodiment;

FIG. 8 is a signaling flow diagram illustrating signaling for a managed inter-NG-WT handover, in accordance with an exemplary embodiment; and

FIG. 9 illustrates MEC local breakout with native cellular and WLAN access.

### DETAILED DESCRIPTION OF THE DRAWINGS

Abbreviations that may be found in the specification and/or the drawing figures are defined below, at the end of the detailed description section.

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

When more than one drawing reference numeral, word, or acronym is used within this description with “/”, and in general as used within this description, the “/” may be interpreted as “or”, “and”, or “both”.

As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

The rest of this disclosure is divided into sections, for ease of reference. The section headings are merely examples and are not intended to be limiting.

### I. Introduction to the Technological Area and its Associated Problems

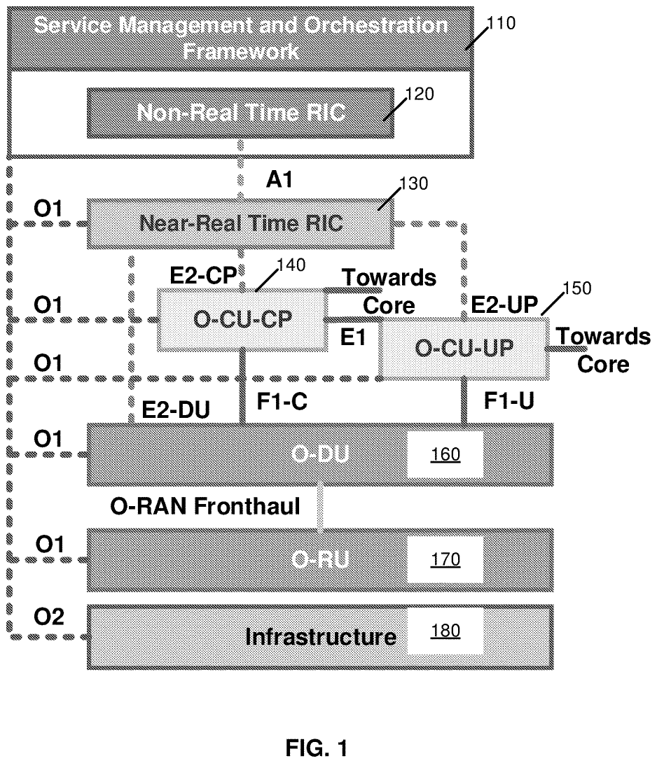

As previously described, an O-RAN (Open Radio Access Network) has been proposed. As also described, O-RAN further disaggregates the DU into two distinct entities—an O-RAN DU (O-DU) and an O-RAN radio unit (O-RU). These are illustrated in FIG. 1, which is a block diagram of an O-RAN reference architecture. This shows a service management and orchestration framework 110, including a non-real time RIC 120, connected to an A1 interface to a near-real time RIC 130. The near-real time RIC 130 is connected through the E2-CP interface to the O-CU-CP 140, through the E2-UP to the O-CU-UP 150, and through the E2-DU interface to the O-DU 160. The O-CU-CP 140 and the O-CU-UP 150 have links that communicate towards a core network (“towards core”), though the core network is not shown in this figure. The O-DU 160 is connected via the O-RAN fronthaul to the O-RU 170. There is an infrastructure portion 180, and the O1 interface connects elements 110/120, 130, 140, 150, 160, 170, and 180.

The non-real time RIC 120 provides configuration management and analytic, views the network, gets AI-based feeds, and provides recommendations to the Near-RT RIC 130 over the A1 interface. Its general task is to support non-real-time optimization of the network and procedures. The A1 interface is used to provide, e.g., policies, enrichment information, Machine Learning (ML) model management towards the Near-RT RIC 130, and to get the policy feedback back to the Non-RT RIC. The near-RT RIC 130 in turn is a software platform to allow applications referred to as xApps to control the RAN. These applications run “on top of” the Near-RT RIC 130, may control operations in the access network, and may analyze data from the access network, such as from O-CU-CP 255 or NG-WT 280. The near-RT RIC 130 enables near real-time control optimization of the RAN elements (called E2 Nodes) via actions sent over the E2 interface. Example xApps include handover optimization, radio link monitoring, mobility management, load balancing, slicing policy updates, traffic steering, and interference management. The E2 interface is a closed loop within the RAN domain, used to send the RIC control and policy towards E2 Nodes and to obtain the feedback from E2 Nodes to the Near-RT RIC.

While several use cases have been proposed for O-RAN such as those relating to traffic steering, QoE optimization, and V2X handover management, the advantages associated with O-RAN lend themselves particularly well to the enterprise wireless use case. With an estimated market size of $10.6 billion by 2025, enterprise wireless networks have been widely recognized as the principal driving force behind the fourth industrial revolution or Industry 4.0. Industry 4.0 is characterized by digitalization and automation across the marketing, manufacturing, operations, and services verticals, and is thus heavily reliant on robust enterprise connectivity. To that end, enterprise wireless represents a fast-rising sector and excellent business opportunity within the broader wireless connectivity domain.

At the outset, enterprise wireless covers a wide gamut of services ranging from logistics and manufacturing to healthcare and retail. For example, logistics enterprises require both in-warehouse and on-road coverage, while manufacturing operations require ultra-dense connectivity. Anchored by both licensed and unlicensed spectrum, such networks require extreme deployment flexibility, the presence of open interfaces for maximizing interoperability and fine-grained control, and compatibility with commercial-off-the-shelf (COTS) hardware. Additionally, the enterprise environment is characterized by the presence of a multitude of devices including but not limited to cellular phones, computing hardware, sensors, actuators, wearables, etc., all of which use different wireless access technologies such as LTE, NR, and WLAN, thus also necessitating the need for network with integrated heterogenous wireless access.

Traditionally, enterprise environments have been WLAN-focused with a heavy emphasis on distributed APs under the purview of an access controller. In parallel, 3GPP-based wireless access has found its way into the enterprise through the burgeoning private wireless sector. However, cellular and WLAN access have long been siloed, each with its own independent operations. The end result has been two disparate access mechanisms operating within the same environment with no scope for use case-based customization or joint programmability, which in turn forms the crux of an exemplary problem addressed by one or more exemplary embodiments herein.

Previously, 3GPP introduced support for WLAN access as part of the LWA and LWIP specifications, but the aforementioned specifications are geared towards monolithic eNBs and has not been updated for the NG-RAN architecture. Consequently, LWA and LWIP are substantially inadequate for modern enterprise networks, necessitating the need for a robust multi-access connectivity solution that leverages LTE, NR, and WLAN access. In designing a multi-access enterprise connectivity solution, it is noted that, while the versatility of O-RAN makes it a perfect fit for enterprise networks, there also exist key challenges in adapting O-RAN for the enterprise.

First, there is a need for a new RAN element that can interface with the O-CU, the Near-RT RIC and WLAN APs, e.g., a nerve center for coordinating WLAN operations. Second, the presence of this new RAN element brings forth the need for a mechanism that allows other O-RAN network function to identify and connect with the proposed RAN element. Third, there is a need for novel service models that expose the control functions and statistics features relevant to multi-access operations, allowing the use of advanced data-driven decision making through the O-RAN Near-RT RIC. Furthermore, the Near-RT RIC also requires enhancements for supporting multi-access operations, including but not limited to a new xApp and E2 interface plugins for multi-access signaling. Finally, there also exist operational considerations such as the need for a control function allocation framework that delegates control responsibilities across the Near-RT RIC and O-CU, in addition to solutions for supporting seamless mobility across the distributed access network.

To that end, the proposed exemplary embodiments address the aforementioned challenges by introducing a multi-access network architecture that leverages key advantages offered by O-RAN while further expanding the scope of O-RAN to include WLAN connectivity. These exemplary embodiments, described after additional description of the technological area, are the first to present an O-RAN-based multi-access framework.

In this context, multi-access refers to a combination of cellular and WLAN connectivity delivered to a single UE. The term “access” may be considered to come from the RAN (radio “access” network) domain. More generally, “access”, as in an access network, is the first point of connection between the user and the service provider. Through exemplary embodiments herein, it is proposed to deliver this access through a combination of cellular and WLAN connectivity, and hence the term multi-access.

3GPP has introduced limited support for RAN-centric multi-access capabilities within LTE through the LWA (or eLWA) specification [1], which includes a Wireless Termination (WT) entity, XwAP [2] and Xw-U [3] protocols, along with corresponding LWA support within RRC [4] and PDCP [5]. Each number surrounded by opening and closing brackets is for a corresponding reference. For [1], see § 22A of 3GPP, “Evolved Universal Terrestrial Radio Access (E-UTRA) and Evolved Universal Terrestrial Radio Access Network (E-UTRAN); Overall description; Stage 2,” Technical Specification (TS) 36.300, July 2021, version 16.6.0. For [2], see 3GPP, “Evolved Universal Terrestrial Radio Access Network (E-UTRAN) and Wireless Local Area Network (WLAN); Xw application protocol (XwAP),” Technical Specification (TS) 36.463, July 2020, version 16.0.0. For [3], see 3GPP, “Evolved Universal Terrestrial Radio Access Network (E-UTRAN) and Wireless Local Area Network (WLAN); Xw interface user plane protocol,” Technical Specification (TS) 36.465, July 2020, version 16.0.0. As to [4], see 3GPP, “Evolved Universal Terrestrial Radio Access (E-UTRA); Radio Resource Control (RRC); Protocol specification,” Technical Specification (TS) 36.331, July 2021, version 16.6.0., and for [5], see 3GPP, “Evolved Universal Terrestrial Radio Access (E-UTRA); Packet Data Convergence Protocol (PDCP) specification,” Technical Specification (TS) 36.323, July 2021, version 16.6.0.

While a key first step in introducing a multi-access RAN, the LWA specification suffers from several critical drawbacks that have precluded its widespread adoption. First, LWA operations are eNB-centric with no room for third-party control, which in turn is one of the biggest draws of the O-RAN architecture. Second, the statistics collection capabilities are extremely limited and do not leverage advanced statistics features supported by IEEE 802.11k, r, and v. Third, LWA does not support mobility and handovers, limiting its practical applicability in large enterprise environments. Furthermore, the LWA specifications have not been updated for NR and NG-RAN, and coupled with the aforementioned drawbacks, are substantially inadequate for modern enterprise networks. On the other hand, it has been noted that LWIP introduces additional overhead due to its use of IPSec tunnels, while also offering lower performance than LWA [see A. Sirotkin, “LTE-WLAN Aggregation (LWA): Benefits and Deployment Considerations,” Intel Corporation, Tech. Rep., 2016].

On the other hand, the standardization efforts within 5G NR have focused on integrating WLAN networks with the 5G core through functions such as the N3IWF, TNGF, and TWIF [see B. Gupta, “IEEE 802.11 and 3GPP 5G System Interworking,” Intel Corporation, Tech. Rep., 2020]. While N3IWF deals with untrusted non-3GPP access, TNGF and TWIF are used for trusted non-3GPP access. At the outset, non-trusted access through N3IWF introduces significant overhead due to the presence of two independent IP layers, a GRE header, an IPSec header, and additional IPSec tunneling encryption. Nonetheless, both N3IWF and TNGF allow for the ATSSS option for traffic steering, switching, and splitting. Network functions related to ATSSS are deployed at both the UE and UPF, i.e., on the network side, the UPF serves as the convergence point for cellular and WLAN access. ATSSS uses either MPTCP or a lower layer multi-link technology called ATSSS-LL Concerning MPTCP, we note that, being a transport layer protocol, MPTCP does not have lower layer visibility, making it sub-optimal wireless aggregation scenarios. On other hand, ATSSS-LL presents its own drawbacks, chief among which is the absence of an overlaying protocol to provide switching and splitting services, thus relegating ATSSS-LL to traffic switching functions only. An absence of traffic switching, and splitting features is detrimental to multi-access operations.

In comparing the RAN and core-centric integration approaches, it is noted that the multi-access convergence point lies within the RAN, or O-CU-CP specifically, for the former, and within the core, or UPF specifically, for the latter. One of the major limitations of a core-based convergence point is its impact on MEC. The LBO feature within MEC is a key enabler of low end-to-end latency by processing traffic within the RAN. However, a core-centric approach to multi-access renders LBO inoperable. On the other hand, a RAN-centric approach is compatible with LBO, since the traffic aggregation is performed within the O-CU-CP, thereby allowing for low-latency operations.

To summarize, the current RAN-centric technology deals exclusively with different implementations of the LWA framework, and therefore also suffers from all the same drawbacks that are associated with LWA. At the same time, as noted previously, LWA does not have a counterpart within 5G NR, and addressing this gap while overcoming the drawbacks of LWA forms a major theme of the proposed exemplary embodiments.

### II. Overview of Exemplary Embodiments

To address these and other issues, the exemplary embodiments herein propose RAN-centric multi-access frameworks with native support for heterogenous radio access technologies including LTE, NR, and WLAN within the O-RAN ecosystem. As described above, what was identified was that some of the key drawbacks of the conventional techniques include eNB-centric operations with no room for third-party control, limited statistics collection capabilities, and a lack of support for mobility and handovers. Furthermore, the RAN-centric approaches within the conventional techniques are all geared towards monolithic RANs, rendering them suboptimal for disaggregated access networks such as NG-RAN and O-RAN. With a view to addressing these shortcomings, the proposed exemplary embodiments may include one or more of the following.
1) Shared control of multi-access operations between the Near-RT RIC and O-CU-CP through a programmable dynamic control plane distribution supporting multiple operational modes geared towards different deployment scenarios.
2) A Next Generation Wireless Termination (NG-WT) entity for WLAN access, with support for enhanced WLAN statistics and data-driven control APIs.
3) A Near-RT RIC-assisted NG-WT discovery framework for efficient automated topology construction.
4) An inter-NG-WT mobility framework for seamless handovers of WLAN access across different NG-WTs in highly distributed RANs.
5) A multi-access RAN function responsible for exposing control functions at the O-CU-CP and statistics features at both the O-CU-CP and NG-WT, coupled with a Multi-Access Manager xApp responsible for the execution of multi-access control directives complete with ML-based decision making.

This overview does not describe all the elements of the exemplary embodiments, but does provide some of the highlights.

### III. Example of a System Architecture

The exemplary embodiments include a multi-access O-RAN architecture with support for heterogenous radio access technologies including LTE, NR, and WLAN within the O-RAN ecosystem. More specifically, as part of an exemplary embodiment, a new multi-access system architecture is introduced that characterized by a Next Generation Wireless Termination (NG-WT) entity for WLAN access along with several new features such as programmable multi-access control plane distribution, near-real time controller-assisted NG-WT discovery, inter-NG-WT mobility, and a RAN function geared towards multi-access operation along with a Multi-Access Manager xApp for the near-real time controller.

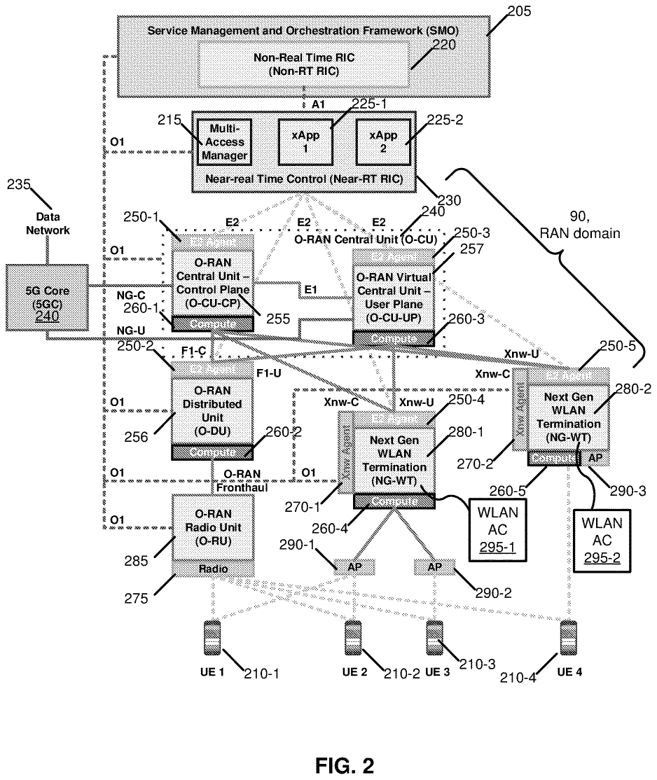

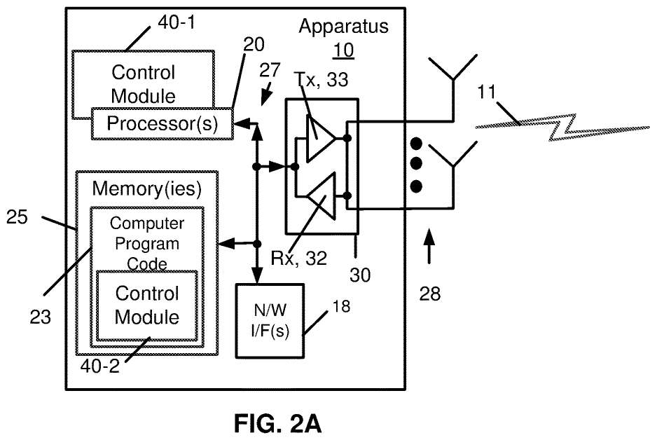

One exemplary proposed system architecture for multi-access operation is illustrated in the block diagram of FIG. 2. FIG. 2 illustrates a Service Management and Orchestration (SMO) framework 205 including a non-real time RIC 220. The non-real time RIC 220 (non-RT RIC), is connected to the near-real time control, near-RT RIC 230, via an A1 interface. The near-RT RIC 230 includes circuitry implementing a multi-access manager xApp 215 and two other xApps, xApp 1 225-1 and xApp 225-2. There is an O-RAN central unit (O-CU) 240, which includes E2 agents 250-1 and 250-3. There are additional E2 agents 250-2, 250-4, and 250-5. The E2 agents include the following in these examples: E2 agent 250-1 includes an O-RAN central unit-control plane (O-CU-CP) 255, and compute circuitry 260-1; E2 agent 250-2 includes an O-RAN distributed unit (O-DU) 256, and compute circuitry 260-2; E2 agent 250-3 includes an O-RAN virtual central unit-user plane (O-CU-UP) 257, and compute circuitry 260-3; E2 agent 250-4 includes a next generation (gen) WLAN termination (NG-WT) 280-1, compute circuitry 260-4, and Xnw Agent 270-1; and E2 agent 250-5 includes a next generation (gen) WLAN termination (NG-WT) 280-2, compute circuitry 260-5, Xnw Agent 270-2, and an Access Point (AP) 290-3.

Also illustrated is an O-RAN radio unity (O-RU) 285 having radio circuitry 275, three access points 290-1, 290-2, and 290-3, and four UEs UE 1 210-1, UE 2 210-2, UE 3 210-3, and UE 4 210-4. A 5G core (5GC) 240 is illustrated, which is coupled to a data network 235, such as the Internet. A RAN domain 90 includes elements 250 and 285. The O-CU-CP 255 is a node handling control plane operations in an ORAN and in particular the RAN domain 90. Similarly, the O-CU_UP is a node handling user plane operations in an ORAN and in particular the RAN domain 90. The near-RT RIC 230 is node handling near-real-time control operations in the ORAN. The NG-WT 280 is a node that provides wireless local area network termination for one or more access points.

In addition to the A1 interface, the following interfaces are illustrated: the O1 interface interconnecting elements 205, 230, 240, 250-2, 250-2, 250-4, 250-5, and 285; the E2 interface interconnecting elements 230 and all of the elements 250; the E1 interface interconnecting elements 250-1 and 250-3; the NG-U interface interconnecting elements 240 and 250-3; the NG-C interface interconnecting elements 240 and 250-1; the Xnw-U interface interconnecting elements 250-3, 250-4, and 250-5; the Xnw-C interface interconnecting elements 250-1, 250-4, and 250-5; the F1-C interface interconnecting elements 250-2 and 250-2; and finally the F1-U interface interconnecting elements 250-1 and 250-4. The UEs 210 are all connected to the radio circuitry 275, and UEs 1 210-1 and 2 210-2 are connected to the AP 290-1, the UE 3 210-3 is connected to the AP 290-2, and the UE 4 210-4 is connected to the AP 290-3.

In further detail, FIG. 2 includes key network functions from the O-RAN reference architecture such as the SMO framework 205, the Near-RT RIC 230, the O-CU-CP 250-1, the O-CU-UP 250-3, the O-DU 250-2, and the O-RU 285. The SMO framework 205 may be considered to be a node that provides service management and orchestration in the ORAN.

In addition, it is proposed to enable support for WLAN access through the Next Generation Wireless Termination (NG-WT) network functions 280-1 and 280-2. While its basic premise is based on the LWA WT provided by 3GPP for LTE-WLAN aggregation, the NG-WT incorporates several improvements as detailed in the following sections to enable the aggregation of WLAN access with LTE and NR within O-RAN. For instance, the NG-WT 280 incorporates an Xnw agent 270 to interface with the O-CU-CP 255-1 and O-CU-UP 257 over the Xnw-C and Xnw-U interfaces, and an E2 agent 250-4, 250-5 to interface with the Near-RT RIC 230 over the E2 interface. Within this context, the Xnw-C and Xnw-U interfaces are intended to replace the Xw interface provided by 3GPP. In general, the XnW interface carries both signaling and data information. The signaling can be from the NG-WT to either the O-CU-CP or Near-RT RIC depending on the mode of operation (described below). In exemplary embodiments, the data information on the other hand, is exchanged between the NG-WT and O-CU-UP.

The NG-WT 280 also includes an integrated WLAN Access Controller (AC) 295-1 or 295-2 and may include an integrated AP (e.g., 290-3). In cases where the AP is not integrated with the NG-WT, multiple APs 290-1, 290-2 can be chained to the NG-WT 280-1 as shown in FIG. 2. And, in turn, multiple NG-WTs 280 can be chained to a single O-CU 240. Furthermore, the proposed architecture may also include a new Multi-Access RAN Function (E2SM-MA) to expose multi-access capabilities across the O-CU-CP and NG-WT along with a corresponding Multi-Access Manager (MAM) xApp 215 to allow, e.g., the Near-RT RIC 230 to control the multi-access operation and collect relevant statistics. The new Multi-Access RAN Function, E2SM-MA, is exhibited in communications between, e.g., the near-RT RIC 230, O-CU-CP 255, and/or NG-WT 280, and in various signaling between those entities.

Turning to FIG. 2A, this figure illustrates an apparatus that may be used for any of the entities in FIG. 2 (or any other figure herein). Apparatus 10 may be used in any of the UE 210, SMO 205, near-RT RIC 230, E2 agents 250, O-RU 285, or APs 190, as examples. The apparatus 10 includes circuitry comprising one or more processors 20, one or more memories 25, one or more transceivers 30, and one or more network (N/W) interfaces (I/Fs) 18 interconnected through one or more buses 27. Each of the one or more transceivers 30 includes a receiver, Rx, 32 and a transmitter, Tx, 33. The one or more buses 27 may be address, data, or control buses, and may include any interconnection mechanism, such as a series of lines on a motherboard or integrated circuit, fiber optics or other optical communication equipment, and the like. The one or more transceivers 30 are connected to one or more antennas 28. The one or more antennas 28 may communicate via wireless link(s) 11.

The N/W I/F(s) 18 may be “wired” network interfaces, such as USB (universal serial bus) or Ethernet or optical network interfaces, depending on the apparatus 10. The apparatus 10 may be wireless, having one or more of the transceivers 30, wired, having one or more N/W I/F(s) 18, or both.

The one or more memories 25 include computer program code 23. The apparatus 10 includes a control module 40, comprising one of or both parts 40-1 and/or 40-2, which may be implemented in a number of ways. The control module 40 may be implemented in hardware as control module 40-1, such as being implemented as part of the one or more processors 20. The control module 40-1 may be implemented also as an integrated circuit or through other hardware such as a programmable gate array. In another example, the control module 40 may be implemented as control module 40-2, which is implemented as computer program code 23 and is executed by the one or more processors 20. For instance, the one or more memories 25 and the computer program code 23 may be configured to, with the one or more processors 20, cause the apparatus 10 to perform one or more of the operations as described herein.

The computer readable memories 25 may be of any type suitable to the local technical environment and may be implemented using any suitable data storage technology, such as semiconductor-based memory devices, flash memory, firmware, magnetic memory devices and systems, optical memory devices and systems, fixed memory and removable memory. The computer readable memories 25 may be means for performing storage functions. The processors 20 may be of any type suitable to the local technical environment, and may include one or more of general-purpose computers, special purpose computers, microprocessors, digital signal processors (DSPs) and processors based on a multi-core processor architecture, as non-limiting examples. The processors 20 may be means for performing functions, such as controlling an entity to perform functions as described herein. The processors 20 and memories 25 may be distributed, such as in a cloud environment, or may be “singular” such as being contained in one physical piece of hardware (such as a rack server).

In general, the various embodiments of the user equipment 210 can include, but are not limited to, a VSAT kind of device, cellular telephones (such as smart phones, mobile phones, cellular phones, voice over Internet Protocol (IP) (VOIP) phones, and/or wireless local loop phones), tablets, portable computers, vehicles or vehicle-mounted devices for, e.g., wireless V2X (vehicle-to-everything) communication, image capture devices such as digital cameras, gaming devices, music storage and playback appliances, Internet appliances (including Internet of Things, IoT, devices), IoT devices with sensors and/or actuators for, e.g., automation applications, as well as portable units or terminals that incorporate combinations of such functions, laptop-embedded equipment (LEE), laptop-mounted equipment (LME), Universal Serial Bus (USB) dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. That is, the UE 110 could be any end device that may be capable of wireless communication. The UE 100 may be fixed or mobile. By way of example rather than limitation, the UE may also be referred to as a communication device, terminal device (MT), a Subscriber Station (SS), a Portable Subscriber Station, a Mobile Station (MS), or an Access Terminal (AT).

### IV. Programmable Multi-Access Control Plane Distribution

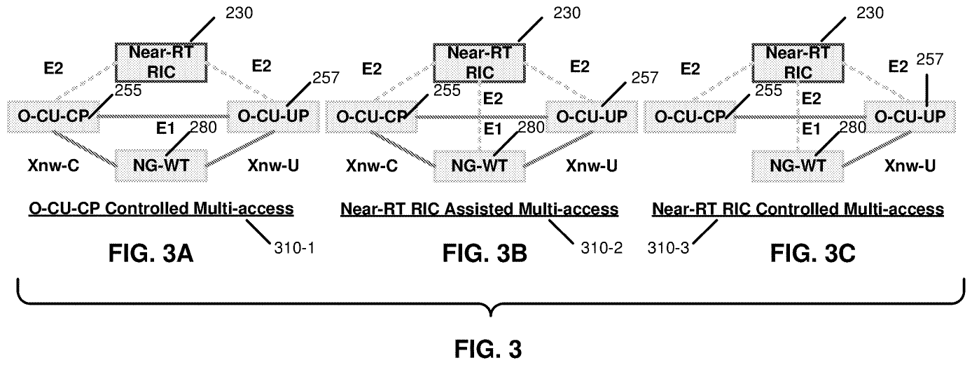

Conventionally, control of traditional LWA operations has been under the purview of the eNB. However, with NG-RAN disaggregating the access network and O-RAN introducing an external near-real time controller, i.e., the Near-RT RIC 230, a complete redesign of the multi-access control framework may be needed. As part of one proposed multi-access O-RAN architecture herein, the control operations may be split between the MAM xApp 215 on the Near-RT RIC 230 and the O-CU-CP 257. More specifically, the control operations within the proposed multi-access framework include NG-WT Discovery, Interface Setup, and Reset; NG-WT Configuration Update; Multi-access Aggregation; and Inter-NG-WT Mobility. Furthermore, the control plane distribution between the O-CU-CP 255 and Near-RT RIC 230 is programmable and can be dynamically adjusted based on either a static policy, wherein the control domain of each entity is established as part of predefined configuration, or a dynamic policy from the SMO that supports seamless transfer of multi-access control capabilities between the O-CU-CP and Near-RT RIC. Consequently, three different modes of operation are identified as shown in FIG. 3.

Turning to FIG. 3, this is a block diagram illustrating possible operational modes 310 for the multi-access control framework, in accordance with exemplary embodiments. FIG. 3 includes FIG. 3A to describe O-CU-CP controlled multi-access mode 310-1, FIG. 3B to describe near-RT RIC assisted multi-access mode 310-2, and FIG. 3C to describe near-RT controlled multi-access mode 310-3. In the O-CU-CP controlled multi-access mode 310-1 (see FIG. 3A), there are E2 interfaces between the near-RT RIC 230 and the O-CU-CP 255 and O-CU-UP 257, an E1 interface between the O-CU-CP 255 and O-CU-UP 257, an Xnw-C between the O-CU-CP 255 and the NG-WT 280, and an Xnw-U interface between the NG-WT 280 and the O-CU-UP 257. Additionally, the entire multi-access control framework is contained within the O-CU-CP 255, with the Near-RT RIC 230 not having a direct role in multi-access control operations, as evidenced by the absence of an active E2 interface between the controller 230 and the NG-WT 280. That is, all control actions are performed by the O-CU-CP 255 in the example of FIG. 3A.

On the other hand, the NG-WT 280 maintains an active E2 interface with the near-RT RIC 230 as part of the Near-RT RIC assisted multi-access mode 310-2 (see FIG. 3B). In this operational mode, the multi-access control responsibilities are distributed between the O-CU-CP 255 and the controller 230 and the exact nature of the distribution depends on the policy set by the SMO 205 (see FIG. 2). For example, the Near-RT RIC 230 can collect WLAN statistics from the NG-WT 280 and then use that information to trigger an Xnw Setup Request from the O-CU-CP 255. Similarly, the Near-RT RIC 230 could monitor resource availability at the NG-WT 280 and then trigger an NG-WT addition request from the O-CU-CP 255 as part of the WLAN aggregation procedure. More generally, the Near-RT RIC assisted multi-access mode 310-2 of operation provides the O-CU-CP 255 with additional visibility into the state of the NG-WT 280, allowing for data-driven actions that are not possible with traditional LWA operations.

Finally, the Near-RT RIC controlled multi-access mode 310-3 in FIG. 3C moves all multi-access control functionality to the Near-RT RIC 230, with the NG-WT 280 no longer maintaining an active Xnw-C interface with the O-CU-CP 255.

The three modes 310-1, 310-2, 310-3 of operation and the resulting distribution of control functionality are all intended to be programmable based on the policy set by the SMO 205. One proposed feature allows for the switching of policies from static to dynamic and vice versa. Within the dynamic policy, seamless switching across the different modes of operation as well as control domains within the Near-RT RIC assisted mode 310-2 of operation are possible. At the same time, it is noted that, irrespective of the mode 310 of operation, the NG-WT 280 deals with XwAP messages exclusively. For control messages that originate from the Near-RT RIC 280, the XnwAP protocol is used over the Xnw-C interface between the RIC 230 and the NG-WT 280. On other hand, for messages originating from the Near-RT RIC 280, the E2SM-NI service model may be used to encapsulate XnwAP messages that are then sent over the E2 interface. At the NG-WT 280, the receiving E2 agent may decapsulate these messages, presenting the constituent XnwAP message to the NG-WT 280. An approach of this kind ensures a streamlined implementation of control operations that involve the NG-WT 280.

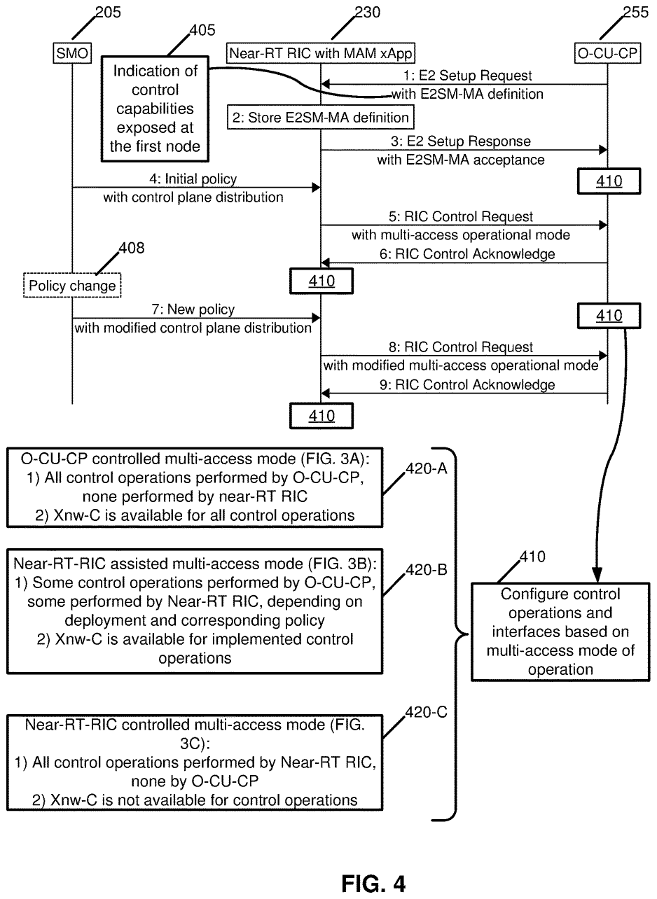

The implementation of the aforementioned feature entails exposing the control functions at the O-CU-CP 255 and statistics capabilities at the both the O-CU-CP 255 and NG-WT 280 via the Multi-Access RAN Function along with providing external support for those control primitives via the MAM xApp 215. Details concerning the proposed RAN function and xApp are provided in a separate section below. Focus is now placed on the realization of the programmable control plane distribution feature with regards to the interactions between the O-CU-CP 255 and Near-RT RIC 230, and also the SMO 205, as shown in FIG. 4, which is a signaling flow diagram illustrating signaling for the programmable multi-access control plane distribution feature, in accordance with an exemplary embodiment.

From FIG. 4, the following message exchange is noted to implement the proposed programmable multi-access control plane distribution feature.
1) First, the E2 Setup Request message sent by the O-CU-CP to the Near-RT RIC contains the E2SM-MA function definition, which includes (see block 405) the control capabilities exposed at the O-CU-CP within the context of multi-access operation. See step 1.
2) Second, the Near-RT RIC 230 stores (step 2) the function definition in, e.g., a RAN database, and responds (step 3) with an E2 Setup Response message indicating RAN function acceptance for E2SM-MA.
3) Then, based on the initial policy set by the SMO via step 4 (with control plane definition), the MAM xApp 215 sends an RIC Control Request message to the O-CU-CP. See step 5. The control message indicates the multi-access mode 310 of operation to be used, along with the specific split of control functionalities if the Near-RT RIC assisted mode 310-2 is to be used.
4) The O-CU-CP 255 responds (step 6) with an RIC Control Acknowledge message indicating a successful control configuration.
5) In a similar manner, the MAM xApp 215 can send additional control requests to the O-CU-CP 255 to modify the mode 310 of operation and scope of multi-access control responsibilities associated with the Near-RT RIC 230 and O-CU-CP 255. Such changes can be triggered by changes to the policy set by the SMO with the end outcome being a programmable control plane split which can be modified on demand. These are illustrated by the policy change 408, the SMO 205 sending a new policy in step 7 with modified control plane distribution, the near-RT RIC 230 sending (step 8) a RIC control request message with modified multi-access operation mode 310, and the O-CU-CP responding (step 9) with a RIC control acknowledge message.

In response to steps 5 and 8, the O-CU-CP 255 changes the multi-access mode 310 of operation, as does the near-RT RIC 230. This is illustrated by block 410, where the O-CU-CP 255 and near-RT RIC 230 configures control operations and interfaces based on multi-access mode 310 of operation. This configuration is illustrated by blocks 420-A, 420-B, and 420-C, where the O-CU-CP 255 and the near-RT RIC 230 switch to the appropriate mode 310. In block 420-A, the O-CU-CP and near-RT RIC 230 switch to controlled multi-access mode 310-1 (FIG. 3A): 1) All control operations performed by O-CU-CP, with none performed by near-RT RIC; and 2) Xnw-C is available for all control operations. In block 420-B, the O-CU-CP 255 and near-RT RIC 230 switch to the Near-RT-RIC assisted multi-access mode 310-2 (FIG. 3B): 1) Some control operations performed by O-CU-CP, some performed by Near-RT RIC, depending on deployment and corresponding policy; and 2) Xnw-C is available for implemented control operations. In block 420-C, the O-CU-CP 255 and the near-RT RIC 230 switch to Near-RT-RIC controlled multi-access mode 310-3 (FIG. 3C): 1) All control operations performed by Near-RT RIC, and none are performed by the O-CU-CP 255; and 2) Xnw-C is not available for control operations.

### V. Near-RT RIC Assisted NG-WT Discovery

Within LWA, to set up and discover the WT, the monolithic eNB should be configured with the WT's address beforehand to initiate the setup request towards the WT. This is a manual step that should be automated in case of large-scale networks with multiple NG-WTs. Furthermore, the WT can reject the setup request due to insufficient resources, or incorrect request parameters, or the like. Then, the eNB should wait and try to re-establish the connection with the WT, resulting in prolonged connection setup times. With the proposed multi-access O-RAN architecture, the Near-RT RIC Assisted NG-WT Discovery feature is introduced to address this issue.

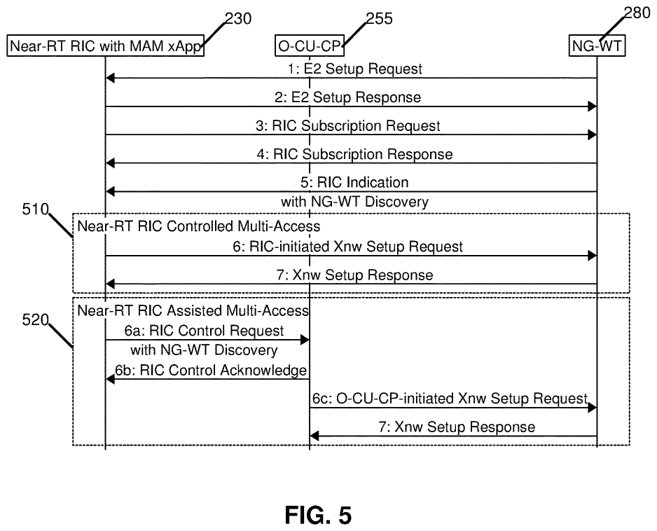

The Near-RT RIC Assisted NG-WT discovery procedure is described in FIG. 5, which is a signaling diagram for the same. An E2 setup may be performed, which is a process that at least performs registration of the NG-WT 280 with the near-RT RIC 230. Following a successful E2 Setup (steps 1 and 2) between the Near-RT RIC 230 and NG-WT 280, a RIC Subscription request is sent (step 3) to the NG-WT 280 by the RIC 230 to request for configuration information or to subscribe for statistics or event notifications, and the NG-WT 280 responds with a RIC Subscription Response in step 4. The NG-WT 280 then provides (step 5) the requested configuration information to the Near-RT RIC via the E2 Indication-NG-WT Discovery message. The NG-WT can indicate support for managed mobility features through an appropriate “managed mobility parameter” within the NG-WT

Discovery message. Then, depending on the mode 310 of operation, the Near-RT RIC can perform either one of the following.
1) Initiate Xnw Setup towards the NG-WT, directly on behalf of the O-CU-CP using E2SM-NI in case of the Near-RT RIC Controlled Multi-Access mode 310-3 of operation. This is illustrated in the Near-RT RIC controlled multi-access block 510, where the near-RT RIC 230 sends (step 6) an RIC-initiated Xnw Setup Request message to the NG-WT 280, and the NG-WT 280 responds (step 7) with an Xnw Setup Response message.
2) Forward the NG-WT information to the O-CU-CP 255 via the RIC Control Request procedure. See the Near-RT RIC Assisted multi-access block 520 and step 6a. The RIC Control Acknowledge response is sent from the O-CU-CP 255. See step 6b. The O-CU-CP 255 then initiates Xnw Setup towards the NG-WT in case of the Near-RT RIC Assisted Multi-Access mode 310-2 of operation. See step 6c. The NG-WT 280 responds with an Xnw Setup Response message in step 7.

The feature brings a seamless setup procedure that does not require prior configuration information and is extremely useful for multiple NG-WT environments. Moreover, the O-CU-CP/Near-RT RIC has additional context before initiating Xnw Setup, thus reducing the chances of Xnw setup rejection from the NG-WT.

### VI. Inter-NG-WT Mobility

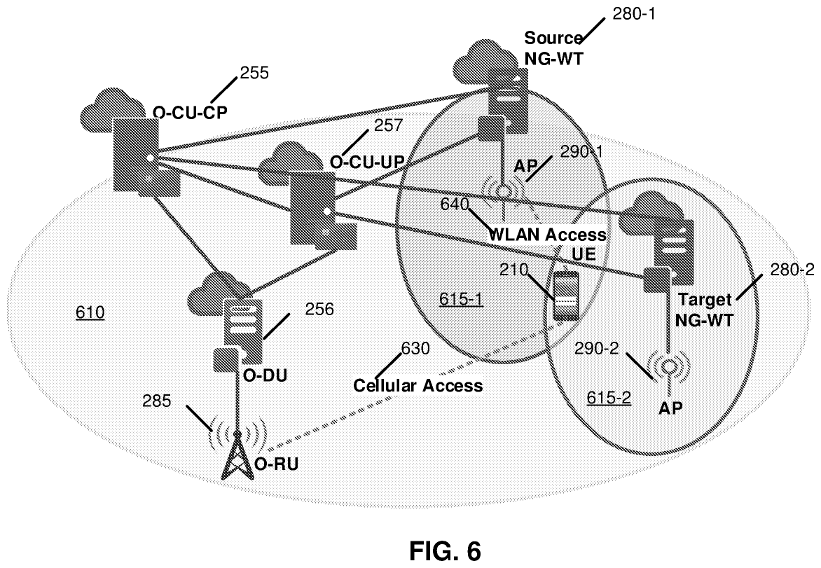

The 3GPP LWA specification incorporates limited support for user mobility by introducing the mobility set, i.e., a set of APs associated with the same NG-WT that the UE can move across without informing the eNB. However, the distributed nature of the O-RAN architecture highlights the limitations of this approach. With multiple O-DUs chained to the same O-CU, the effective coverage area of the O-CU is greatly enhanced. As illustrated in FIG. 6, which illustrates an Inter-NG-WT mobility scenario, in accordance with an exemplary embodiment. The O-RU 285 forms a cell 610 in which the UE 210 is traveling, and the UE 210 is connected via a cellular access wireless link 630 to the O-RU 285. There is an O-CU-CPs 255 and a O-CP-UP 257, the O-DU 256, a source NG-WT 280-1, a target NG-WT 280-2, each of which is connected to corresponding APs 290-1 and 290-2, each of which creates its own “cell” 615-1, 615-2. The UE 210 is shown connected via wireless access link 640 (WLAN access) to the AP 290-1.

As FIG. 6 illustrates, as the UE 210 moves across different O-DUs 256, the UE may come within the range of APs 290 that are not associated with the first NG-WT 280-1, thus necessitating the need for a mobility framework that functions across NG-WTs 280. An inter-NG-WT mobility framework of this kind is especially useful in dense multi-access environments characterized by a large number of O-DUs 256 and NG-WTs 280. Furthermore, it is noted that a focus herein is on mobility with regards to the interactions between the Near-RT RIC, the O-CU-CP, and the NG-WTs, and mobility considerations concerning interactions between NG-WTs and APs are outside the scope of this document.

One exemplary proposed feature herein relies on the precondition that both the source 280-1 and target 280-2 NG-WTs are connected to the same O-CU-CP 255 to ensure compatibility with all three multi-access operational modes. Additionally, it is noted that there are two classes of WLAN networks and devices—legacy and managed. The legacy class includes NG-WTs and devices that do not support WLAN connection management specifications such as IEEE 802.11k, r, and v, while the managed class incorporates support for the aforementioned standards. Multi-access capable UEs can indicate support for managed mobility features through a “managed multi-access handover with NG-WT change” parameter within the general UE radio access capability parameters message sent to the O-CU-CP 255. On the other hand, the absence of this parameter identifies a legacy class UE. Similarly, as part of the NG-WT discovery process, the corresponding NG-WT can indicate support for managed mobility features through an appropriate “managed mobility parameter” within the NG-WT Discovery message. At the same time, it is noted that one proposed inter-NG-WT mobility framework incorporates support for both classes, with tailored mobility mechanisms for each class. Therefore, two categories of handovers are introduced within the inter-NG-WT mobility framework: legacy inter-NG-WT handovers; and managed inter-NG-WT handovers.

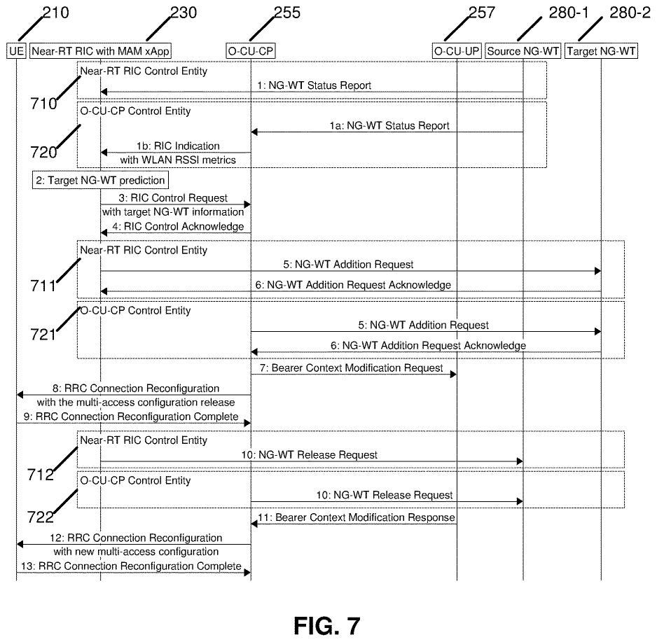

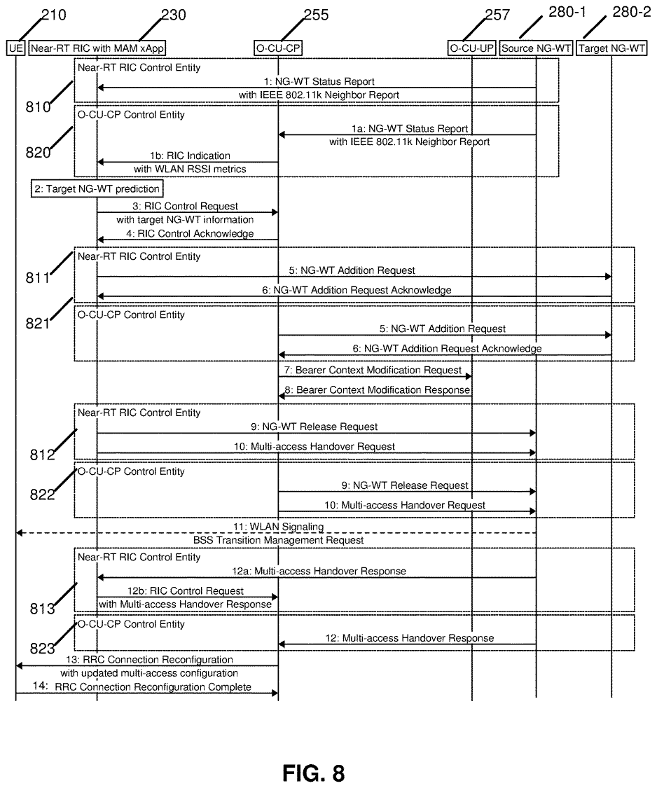

At the outset, legacy inter-NG-WT handovers are used when either entity, i.e., NG-WT 280-1 or UE 210, does not belong to the managed class. An example of this is illustrated in FIG. 7. FIG. 8, by contrast, shows an example when both the NG-WT 280-1 and UE 210 belong to the managed class. Within the context of FIGS. 7 and 8, the term “control entity” refers to either the O-CU-CP 255 or the MAM xApp 215 on the Near-RT RIC 230, depending upon the multi-access mode 310 of operation. The steps taken depend on which control entity is used.

The signaling exchange for implementing the legacy inter-NG-WT handover is shown in FIG. 7, which is a signaling flow diagram illustrating signaling for a managed inter-NG-WT handover, in accordance with an exemplary embodiment.

From FIG. 7, the following are noted. For FIG. 7, if the control entity is the MAM xApp 215 in the near-RT RIC 230, blocks 710, 711, and 712 apply; meanwhile, if the control entity is the O-CU-CP 255, blocks 720, 721, and 722 apply instead.

Furthermore, as an overview, the UE (e.g., in response to step 8) enters cellular-only mode (no WLAN) during the handover process. However, since FIG. 7 illustrates a legacy handover, it is likely not possible to force the UE to connect to a specific NG-WT. Instead, the prediction model (see step 2) at the Near-RT RIC identifies the target NG-WT that the UE is most likely to connect with (based on past mobility patterns, for example). Therefore, when the UE connects with an AP associated with the target NG-WT, the O-CU-CP sends the new multi-access configuration in order to “enable” connectivity with the new NG-WT.
1) Based on the multi-access mode of operation, the source NG-WT 280-1 sends an NG-WT Status Report to the appropriate control entity (in the near-RT RIC 230 in block 710 and step 1, or in the O-CU-CP 255 in block 720 and step 1a) which then forwards the relevant content to the Near-RT RIC 230, if required (i.e., as it is in step 1b, where the O-CU-CP 255 sends an RIC indication with the WLAN RSSI metrics). The status report is for APs connected to the NG-WT, and may also include UE-related information such as the UE's signal strength, along possibly with load levels and resource utilization at each AP.

Ultimately, the information received at the Near-RT RIC 230 contains the WLAN RSSI of the UE under consideration. Based on past mobility patterns and the WLAN network topology, an ML model deployed as part of the MAM xApp 215 predicts (step 2) whether an NG-WT change is imminent, identifies the target NG-WT, and informs the O-CU-CP of this change. See step 3, where the near-RT RIC 230 sends an RIC control request message to the O-CU-CP 255, and the O-CU-CP 255 responds (step 4) with an RIC control acknowledge message.
2) Upon detecting a change in the NG-WT, the control entity sends (step 5) an NG-WT Addition Request to the predicted target NG-WT 280-2 containing a list of QoS flows to be added for the incoming UE. The target NG-WT 280-2 responds with an NG-WT addition request acknowledge message in step 6. In block 711, the control entity is the MAM xApp 215 in the near-RT RIC 230a, whereas in block 721, the control entity is the O-CU-CP 255.
3) Then, the O-CU-CP issues (step 7) a Bearer Context Modification Request to the O-CU-UP for modifying the Xnw-U tunnel endpoints to reflect the target NG-WT.
4) The O-CU-CP 255 then uses a multi-access configuration parameter, within RRC signaling (RRC Connection Reconfiguration), to direct the UE to release the multi-access configuration and switch to a cellular-only mode (see step 8), along with an NG-WT Release Request from the control entity (the MAM xApp 215 in the near-RT RIC 230 in block 712 or the O-CU-CP 255 in block 722) to the source NG-WT (step 10) containing a list of QoS flows to be released for the UE under consideration. The UE 210 responds to the O-CU-CP 255 with an RRC connection reconfiguration complete message in step 9.
5) Upon receiving (step 11) a Bearer Context Modification Response from the O-CU-UP, the O-CU-UP sends (step 12) another RRC Connection Reconfiguration to the UE indicating the updated multi-access configuration.
6) The UE responds (step 13) with an RRC Connection Reconfiguration Complete message indicating the end of the legacy inter-NG-WT handover procedure.

It is noted that the UE most likely does not contact the target NG-WT 280-2 directly. Instead, it is assumed that the UE is now within the range of an AP associated with the target NG-WT 280-2 and can transfer data through that AP, on account of the NG-WT Addition Request (step 5) configuring resources at the target NG-WT for that UE, and the new multi-access configuration received from the O-CU-CP 255.

On the other hand, when both entities belong to the managed class, the proposed framework performs a managed inter-NG-WT handover as illustrated in FIG. 8. From FIG. 8, the following signaling exchange is noted. For FIG. 8, if the control entity is the MAM xApp 215 in the near-RT RIC 230, blocks 810, 811, 812, and 813 apply; meanwhile, if the control entity is the O-CU-CP 255, blocks 820, 821, 822, and 823 apply instead.

As an overview, the handover for a UE between access points can be controlled more by the network as compared to FIG. 7. In particular, the network can control addition requests to a new NG-WT and release requests to a current NG-WT, and provide configuration to the UE for use in the handover. For instance, the network in, e.g., step 13 (described below) may provide configuration to allow the UE to utilize a newly associated NG-WT for connectivity.
1) For managed class NG-WTs, the NG-WT Status Report contains the 802.11k neighbor report. The MAM xApp 215 uses the neighbor report in conjunction with past mobility patterns to select the target NG-WT and corresponding AP. In block 810, the source NG-WT 280-1 sends (step 1) the NG-WT status report to the near-RT RIC 230, whereas in block 820 the source NG-WT 280-1 sends (step 1a) the report to the O-CU-CP 255, which then sends (step 1b) an RIC indication with WLAN RSSI metrics to the near-RT RIC 230.
2) Steps 2, 3 and 4 are the same as in FIG. 7.
3) Depending on the operational mode 310, the appropriate control entity issues (step 5) an NG-WT Addition Request to the target NG-WT containing a list of QoS flows to be added for the incoming UE. This is acknowledged via an NG-WT addition request acknowledge message in step 6. For block 811, the control entity is the MAM xApp 215 of the near-RT RIC 230, and for block 821, the control entity is the O-CU-CP 255.
4) The O-CU-CP 255 sends (step 7) a Bearer Context Modification Request to the O-CU-UP for modifying the Xnw-U tunnel endpoints to reflect the target NG-WT, followed by (step 8) a Bearer Context Modification Response from the O-CU-UP 257.
5) Then, the control entity issues (step 9) an NG-WT Release Request to the source NG-WT containing a list of QoS flows to be released for the UE under consideration, followed by (step 10) an XnwAP Multi-access Handover Request message from the control entity to the source NG-WT. For block 812, the control entity is the MAM xApp 215 of the near-RT RIC 230, and for block 822, the control entity is the O-CU-CP 25
6) The source NG-WT then sends (step 11) an 802.11v BSS Transition Management Request to the UE over WLAN signaling indicating the target AP (and thus target NG-WT 280-2), followed by an XnwAP handover response message from the source NG-WT to the control entity. In block 813, the multi-access handover response from the source NG-WT 280-1 goes (step 12a) to the near-RT RIC 230, then the near-RT RIC 230 sends (step 12b) an EIC control request with multi-access handover response to the O-CU-CP 255. In block 823, the multi-access handover response from the source NG-WT 280-1 goes (step 12) to the O-CU-CP 255.
7) Upon receiving the XnwAP handover response, the O-CU-CP 255 uses RRC signaling to update the multi-access configuration at the UE. See step 13.
8) The UE responds (step 14) with an RRC Connection Reconfiguration Complete message indicating the end of the managed inter-NG-WT handover.

The UE may contact the target NG-WT 280 in response to step 11 in FIG. 8. Step 13 then provides the necessary configuration to allow the UE to utilize the newly associated NG-WT for connectivity.

In this manner, the proposed framework enables mobility features for all kinds of end-user devices, APs, and NG-WTs.

### VII. Multi-Access RAN Function (E2SM-MA) and Multi-Access Manager xApp

The Multi-Access RAN function and accompanying service model, E2SM-MA, along with the Multi-Access Manager xApp 215 are enablers for programmable multi-access operations within the O-RAN ecosystem, in exemplary embodiments. As has been highlighted in the preceding sections, while E2SM-MA is responsible for exposing control functions at the O-CU-CP and statistics features at both the O-CU-CP and NG-WT, the MAM xApp 215 is responsible for the execution of multi-access control directives.

At the O-CU-CP 255, E2SM-MA provides for the control plane distribution feature by implementing both the dynamic offloading of multi-access-related control functions to the Near-RT RIC and the corresponding messaging over the E2 interface. The service model specific message contents within E2AP Global Procedures and Near-RT RIC Functional procedures are all provided by the Multi-Access RAN function. More specifically, the proposed E2SM-MA model defines the aforementioned three modes 310 of operation-O-CU-CP controlled multi-access 310-1, Near-RT RIC assisted multi-access 310-2, and Near-RT RIC controlled multi-access 310-3, along with the control domains of the O-CU-CP 255 and Near-RT RIC 230 for the assisted mode of operation. Furthermore, the statistics exchanged between the NG-WT and both the Near-RT RIC and O-CU-CP during the Near-RT RIC Assisted NG-WT Discovery process are also defined, in exemplary embodiments, by the proposed E2SM-MA and may include metrics such as radio and transport resource availability at the associated APs, total estimated throughput, and/or the number of connected STAs along with their RSSI values.

E2SM-MA may also play role in the mobility framework. First, for operational modes where the O-CU-CP is the corresponding control entity, E2SM-SA defines the NG-WT statistics that are sent from the O-CU-CP to the Near-RT RIC in the RIC Indication message along with the event trigger for the statistics report. Such statistics may include at the very least, RSSI values for all UEs associated with that NG-WT and may also include neighbor report statistics should the NG-WT be equipped with IEEE 802.11k, r, v features. Then, the handover decision from the xApp to the O-CU-CP also leverages signaling defined by E2SM-MA. More generally, any information that is exchanged between the O-CU-CP and the MAM xApp is governed by E2SM-MA. Similarly, any information that is exchanged between the NG-WT 280 and MAM xApp 216, excluding encapsulated XnwAP messages, may also be governed by E2SM-MA.

While E2SM-MA exposes control and statistics features at the O-CU-CP and NG-WT the MAM xApp 215 is responsible for leveraging the received statistics along with the policies from the SMO 205 to execute key control functions, in exemplary embodiments. In designing the proposed xApp, it is noted that the MAM interacts with the O-CU-CP through E2SM-MA and with the NG-WT through E2SM-NI in at least some embodiments. Furthermore, it is noted that two distinct classes of functions within the domain of the MAM are shared functions and dedicated functions. Shared functions, as the name suggests, are those functions that the MAM xApp shares with the O-CU-CP. Examples of such functions may include, but are not limited to, NG-WT Interface Setup and Reset procedures, the NG-WT Configuration Update procedure, the multi-access aggregation feature, and parts of the inter-NG-WT mobility feature excluding handover decisions. The aforementioned functions can be implemented at either the O-CU-CP or the NG-WT without any loss in functionality.

On the other hand, the dedicated functions are exclusive to the MAM xApp and include the NG-WT Discovery procedure along with the handover decision within the inter-NG-WT mobility framework accompanied by the signaling to and from the Near-RT RIC. These dedicated functions cannot be offloaded to the O-CU-CP, and in the absence of a corresponding MAM xApp, the overall multi-access framework operates in a reduced mode. For example, in this mode, NG-WT discovery might not be possible, and the O-CU-CP therefore initiates the NG-WT Interface Setup without prior NG-WT information.

Furthermore, in the absence of the MAM xApp, the inter-NG-WT mobility framework is rendered inoperable due to a lack of ML-based prediction capabilities.

### VIII. Example Use Cases

While there are many possible use cases, a few cases below are used as examples.

### VIII.a. Multiaccess Edge Computing

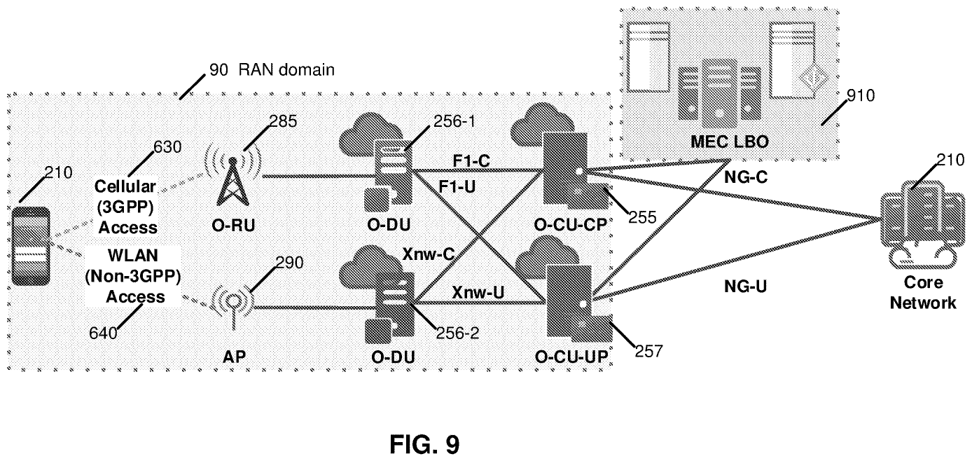

MEC (Multiaccess Edge Computing) aims to move computing power and data processing to the network edge closer to the end-user. This enables real-time, high-bandwidth, low-latency network connectivity to end-users across large enterprises, and entities with wide areas and high occupancies. More specifically, the proposed techniques herein are enablers for MEC LBO operations as shown in FIG. 9. In FIG. 9, three major elements are illustrated: a RAN domain 90, an MEC LBO 910, and a core network 210. The RAN domain 90 includes the UE 210 in this example, but the UE 210 may also be considered to be outside the RAN domain 90. The RAN domain 90 includes the O-RU 285, the AP 290, O-DUs 256-1 and 256-2, the O-CU-CP 255, and the O-CU-UP 257.

The UE 210 is connected to RAN domain 90 through cellular (3GPP) access (i.e., a radio link) 630 the O-RU 285 and through WLAN (non-3GPP) access (i.e., another radio link) 640 to the AP 290. The O-RU 285 is connected to the O-DU 256-1, while the AP 290 is connected to the O-DU 256-2. The O-DU 256-1 is connected via an F1-C interface to the O-CU-CP 255 and via the F1-U interface to the O-CU-UP 257. The O-DU 256-2 is connected via an Xnw-C interface to the O-CU-CP 255 and via the Xnw-U interface to the O-CU-UP 257. The O-CU-CP 255 is connected to the MEC LBO 910 via an NG-C interface and to the core network 240 via an NG-U interface. The O-CU-UP 257 is connected to the MEC LBO 910 via an NG-C interface and to the core network 240 via an NG-U interface.

Unlike the other multi-access techniques used in conventional techniques, the proposed multi-access O-RAN framework is uniquely positioned to deliver both cellular and WLAN connectivity to the LBO 910, thereby enabling use cases such as AR, VR, vehicular connectivity, to name a few.

### VIII.b. Hospitals

Hospitals having large buildings, high occupation, retention of confidential patient information visits, tracking of prescriptions, and mission-critical life support devices that demand reliable performance 24/7. The healthcare environment is characterized by a plethora of sensors for tracking, all requiring ultra-low latency and reliable coverage across the campus. Furthermore, medical devices sharing health information with doctors and nurses can use the proposed multi-access O-RAN with cellular and WLAN to transmit information securely across the network using device authentication and ensure specific service level metrics such as high throughput guarantees for real-time imaging and latency enforcement for voice traffic.

### VIII.c. Stadiums and Arenas

Stadiums are wide open areas densely packed with fans, TV camera crews, reporters, and sports organizers who all want live real-time connectivity. This requires large-area coverage with high predictability in performance. The proposed multi-access O-RAN will be instrumental in meeting high traffic demands. Audiences will be able to unlock rich, real-time content for meaningful engagement. Multi-access networks can seamlessly cover entire indoor and outdoor areas of large stadiums and arenas, integrating with existing DAS solutions. The resulting robust connectivity can be used for video surveillance, ticketing, computer vision sensors and IoT maintenance infrastructure.

### VIII.d. Public Transportation

Buses, trolleys, ferries, shuttles, trains, and other public transit vehicles often experience a lack of consistent network connectivity. This poses a problem for radio communications, especially for maintenance vehicles, field command vehicles, and IoT devices. More specifically, concerning maintenance, existing WLAN solutions in maintenance depots can be integrated with cellular systems to improve the quality of connectivity. On the other hand, for public transit vehicles in motion, an onboard NG-WT can be provided WLAN access which can then be coupled with existing cellular networks for providing consistent multi-access connectivity to transit users. In this manner, combining both cellular and WLAN connectivity will improve the performance of network.

### IX. Additional Examples and Details

Without in any way limiting the scope, interpretation, or application of the claims appearing below, technical effects and advantages of one or more of the example embodiments disclosed herein include one or more of the following:
1) Leveraging the O-RAN architecture also gives rise to the possibility of introducing new network control functionalities and assurance frameworks that are geared specifically towards the access network by incorporating a programmable open-software development approach.
2) RAN disaggregation allows for flexibility and agility in deployment.
3) Enabling open APIs and standard interfaces provides unprecedented interoperability.
4) Maximizing the use of common-off-the-shelf hardware and merchant silicon helps achieving cost optimization.
5) Minimizing proprietary hardware lowers OPEX and CAPEX costs.
6) The multi-access O-RAN framework increases network capacity and improves user experience, while enhancing network management capabilities.
7) A RAN-centric approach to multi-access also allows for low-latency use cases with full compatibility for the MEC LBO option.
8) Building upon the LWA foundation also provides a cost-effective upgrade path as existing WTs can be turned into NG-WTs through a software upgrade, which is extremely economical in case of large-scale deployments.

The following are additional exemplary embodiments.

Example 1. A method, comprising:
sending, by a first node handling control plane operations in an open radio access network to a second node handling near-real-time control operations in the open radio access network, one or more messages comprising indication of control capabilities exposed at the first node within context of multi-access operation between the first node, second node, and a third node that provides wireless local area network termination for one or more access points;
receiving, at the first node from the second node, an indication of one of multiple-access modes for multi-access operation; and
configuring which control operations of the control capabilities are able to be provided by the first node based on the received indication.

Example 2. The method according to example 1, wherein there are first, second, and third modes of the multiple modes, and wherein the received indication indicates the first of the multiple modes and the configuring and using control operations of the control capabilities comprises configuring the first node to provide all of the control operations of the control capabilities.

Example 3. The method according to example 1, wherein there are first, second, and third modes of the multiple modes, and wherein the received indication indicates the second of the multiple modes and the configuring and using control operations of the control capabilities comprises configuring the first node to provide some of the control operations of the control capabilities, and wherein the second node is to provide others of the control operations of the control capabilities.

Example 4. The method according to any one of examples 2 or 3, wherein:
the first node uses, in the first mode and the second mode, a control interface between the first and third nodes for control operations.

Example 5. The method according to example 1, wherein there are first, second, and third modes of the multiple modes, and wherein the received indication indicates the third of the multiple modes and the configuring and using control operations of the control capabilities comprises configuring the first node to provide none of the control operations of the control capabilities, and wherein the second node is to provide all of the control operations of the control capabilities.

Example 6. The method according to example 5, wherein:
the first node, in the third mode, does not provide for use of a control interface between the first and third nodes.

Example 7. A method, comprising:
in an open radio access network having a first node handling control plane operations in the open radio access network, receiving at a second node one or more messages from the first node comprising indication of control capabilities exposed at the first node within context of multi-access operation between the first node, second node, and a third node that provides wireless local area network termination for one or more access points, the second node handling near-real-time control operations in the open radio access network;
sending, from the second node to the first node, an indication of one of multiple-access modes for multi-access operation; and
configuring and using control operations of the control capabilities that are able to be provided by the second node based on the sent indication.

Example 8. The method according to example 7, wherein there are first, second, and third modes of the multiple modes, and wherein the sent indication indicates the first of the multiple modes and the configuring and using control operations of the control capabilities comprises configuring the second node to provide none of the control operations of the control capabilities and wherein the first node is to provide all of the control operations of the control capabilities.

Example 9. The method according to example 8, wherein the second node does not provide for use of a control interface between the second and third nodes.

Example 10. The method according to example 7, wherein there are first, second, and third modes of the multiple modes, and wherein the sent indication indicates the second of the multiple modes and the configuring and using control operations of the control capabilities comprises configuring the second node to provide some of the control operations of the control capabilities, and wherein the first node is to provide others of the control operations of the control capabilities.

Example 11. The method according to example 7, wherein there are first, second, and third modes of the multiple modes, and wherein the sent indication indicates the third of the multiple modes and the configuring and using control operations of the control capabilities comprises configuring the second node to provide all of the control operations of the control capabilities, and wherein the first node is to provide all of the control operations of the control capabilities.

Example 12. The method according to any one of examples 10 or 11, wherein:
the second node uses, in the second mode and the third mode, a control interface between the second and third nodes for control operations.

Example 13. A method, comprising:
in an open radio access network having a first node handling control plane operations in the open radio access network, a second node handling near-real-time control operations in the open radio access network, and a third node that provides wireless local area network termination for one or more access points, determining at a fourth node a policy affecting control plane distribution to be used between the first and second nodes, wherein the fourth node provides service management and orchestration in the open radio access network; and
sending, based on the policy, from the fourth node to the second node indication of control plane distribution to be used between the first and second nodes.

Example 14. The method according to example 13, further comprising performing a policy change, and sending, based on the policy change, from the fourth node to the second node indication of a new control plane distribution to be used between the first and second nodes, the new control plane distribution replacing a current control plane distribution already in use.

Example 15. A method, comprising:
in an open radio access network comprising a first node handling control plane operations and a second node handling near-real-time control operations, performing by a third node in the open radio access network a set up process between the third and second node to register the third node with the second node, the third node providing wireless local area network termination for access points; and
sending, from the third node to the second node, a message indicating any access points discovered and accessible by the third node.

Example 16. The method according to example 15, further comprising receiving, at the third node from the second node, indication of interface configuration for an interface for control plane communications for the open radio access network, and setting configuration at the third node as to whether control plane communications are solely from the first node, partly from the first node and partly from the second node, or solely from the second node.

Example 17. The method according to any one of examples 15 or 16, further comprising:
sending by the third node a status report to be ultimately received at the second node, the status report at least for one or more access points whose wireless local area network termination is provided by the third node;
receiving at the third node a request to release one or more flows for the user equipment that flow through the access point;
releasing by the third node the one or more flows.

Example 1. The method according to any one of examples 15 or 16, further comprising:
receiving by the third node an addition request for a user equipment comprising indication of one or more flows to be added for the user equipment.

Example 19. The method according to any one of examples 15 or 16, further comprising:
sending by the third node a status report to be ultimately received at a control entity controlling at least handover for user equipment between access points, the status report at least for one or more access points whose wireless local area network termination is provided by the third node and comprising indication of other access points whose wireless local area network termination is provided by the third node;
receiving at the third node a request to release one or more flows for the user equipment that flow through the access point;
releasing by the third node the one or more flows; and
sending a handover response from the third node to the control entity.

Example 20. The method according to any one of examples 15 or 16, further comprising:
receiving by the third node an addition request for a user equipment comprising indication of one or more flows to be added for the user equipment, the addition request from a control entity controlling at least handover for user equipment between access points.

Example 21. A method, comprising:
in an open radio access network comprising a first node handling control plane operations, a second node handling near-real-time control operations, and a third node providing wireless local area network termination for access points in the open radio access network, performing a set up process between the second and third node to register the third node with the second node, the third node; and
receiving, at the second node from the third node, a message indicating any access points discovered and accessible by the third node.

Example 22. The method according to example 21, further comprising sending, from the second node to the third node, indication of interface configuration for an interface for control plane communications for the open radio access network, and setting configuration at the second node as to whether control plane communications are solely from the first node, partly from the first node and partly from the second node, or solely from the second node.

Example 23. The method according to any one of examples 21 to 22, further comprising sending, by the second node to the first node, indication of the access points discovered and accessible by the third node and received in the message.

Example 24. The method according to any one of examples 21 to 23, further comprising:
receiving, by the second node from the third node, a status report at least for one or more access points whose wireless local area network termination is provided by the third node;
performing a prediction indicating the third node should be changed for a user equipment to another node providing wireless local area network termination for access points, wherein the user equipment is connected to an access point whose wireless local area network termination is provided by the third node; and
sending, by the second node to the third node and in response to the prediction, a request to release one or more flows for the user equipment that flow through the access point.

Example 25. The method according to example 24, further comprising:
sending, by the second node to the other node and in response to the prediction, an addition request for the user equipment comprising indication of one or more flows to be added for the user equipment.

Example 26. The method according to any one of examples 21 to 23, further comprising:
receiving, at the second node from the third node, a status report for one or more access points whose wireless local area network termination is provided by the third node and comprising indication of other access points whose wireless local area network termination is provided by the third node;
performing a prediction indicating the third node should be changed for a user equipment to another node providing wireless local area network termination for access points, wherein the user equipment is connected to an access point whose wireless local area network termination is provided by the third nod; and
sending, from the second node to the third node, a request to release one or more flows for the user equipment that flow through the access point;
receiving, at the second node from the third node, a handover response indicating the one or more flows for the user equipment have been released.

Example 27. The method according to example 26, further comprising:
sending, from the second node to the other node, an addition request for a user equipment comprising indication of one or more flows to be added for the user equipment.

Example 28. A method, comprising:
in an open radio access network comprising a first node handling control plane operations, a second node handling near-real-time control operations, and a third node providing wireless local area network termination for access points in the open radio access network, receiving at the first node from the second node a message comprising indication of access points discovered and accessible by the third node;
performing a process between the first node and the third node second node to set up ab interface between the first and third nodes for control operations.

Example 29. The method according to example 28, further comprising:
receiving information indicating a user equipment is to change from an original access point having its wireless local area network termination terminated by the third node to a new access point having its wireless local area network termination terminated by another node;
sending, from the first node to the other node, a request to add one or more flows for the user equipment that will flow through the new access point for the other node; and
sending, from the first node to the second node, a message indicating the one or more flows for the user equipment can be routed through the new access point and the one or more flows can be released from the original access point.

Example 30. The method according to example 29, wherein the message indicating the one or more flows for the user equipment can be routed through the new access point and the one or more flows can be released from the original access point is part of a connection reconfiguration message, wherein the method includes receiving a reconfiguration complete message by the first node, and sending, from the first node to the third node, a message indicating the one or more flows for the user equipment can be released from the original access point.

Example 31. The method according to example 28, further comprising:
receiving information indicating a user equipment is to change from an original access point having its wireless local area network termination terminated by the third node to a new access point having its wireless local area network termination terminated by another node;
sending, from the first node to the other node, a request to add one or more flows for the user equipment that will flow through the new access point for the other node;
sending, from the first node to the third node, a message indicating the one or more flows for the user equipment can be released from the original access point;
sending, from the first node to the third node, a message requesting the one or more flows for the user equipment be handed over from the original access point to the new access point and corresponding other node;
receiving, at the first node from the third node, a response indicating a handover from the original access point to the new access point and corresponding other node is complete.

Example 32. A computer program, comprising code for performing the methods of any of examples 1 to 31, when the computer program is run on a computer.

Example 33. The computer program according to example 32, wherein the computer program is a computer program product comprising a computer-readable medium bearing computer program code embodied therein for use with the computer.

Example 34. The computer program according to example 32, wherein the computer program is directly loadable into an internal memory of the computer.

Example 35. An apparatus, comprising means for performing:
sending, by a first node handling control plane operations in an open radio access network to a second node handling near-real-time control operations in the open radio access network, one or more messages comprising indication of control capabilities exposed at the first node within context of multi-access operation between the first node, second node, and a third node that provides wireless local area network termination for one or more access points;
receiving, at the first node from the second node, an indication of one of multiple-access modes for multi-access operation; and
configuring which control operations of the control capabilities are able to be provided by the first node based on the received indication.

Example 36. The apparatus according to example 35, wherein there are first, second, and third modes of the multiple modes, and wherein the received indication indicates the first of the multiple modes and the configuring and using control operations of the control capabilities comprises configuring the first node to provide all of the control operations of the control capabilities.

Example 37. The apparatus according to example 35, wherein there are first, second, and third modes of the multiple modes, and wherein the received indication indicates the second of the multiple modes and the configuring and using control operations of the control capabilities comprises configuring the first node to provide some of the control operations of the control capabilities, and wherein the second node is to provide others of the control operations of the control capabilities.

Example 38. The apparatus according to any one of examples 36 or 37, wherein:
the first node uses, in the first mode and the second mode, a control interface between the first and third nodes for control operations.

Example 39. The apparatus according to example 35, wherein there are first, second, and third modes of the multiple modes, and wherein the received indication indicates the third of the multiple modes and the configuring and using control operations of the control capabilities comprises configuring the first node to provide none of the control operations of the control capabilities, and wherein the second node is to provide all of the control operations of the control capabilities.

Example 40. The apparatus according to example 39, wherein:
the first node, in the third mode, does not provide for use of a control interface between the first and third nodes.

Example 41. An apparatus, comprising means for performing:
in an open radio access network having a first node handling control plane operations in the open radio access network, receiving at a second node one or more messages from the first node comprising indication of control capabilities exposed at the first node within context of multi-access operation between the first node, second node, and a third node that provides wireless local area network termination for one or more access points, the second node handling near-real-time control operations in the open radio access network;
sending, from the second node to the first node, an indication of one of multiple-access modes for multi-access operation; and
configuring and using control operations of the control capabilities that are able to be provided by the second node based on the sent indication.

Example 42. The apparatus according to example 41, wherein there are first, second, and third modes of the multiple modes, and wherein the sent indication indicates the first of the multiple modes and the configuring and using control operations of the control capabilities comprises configuring the second node to provide none of the control operations of the control capabilities and wherein the first node is to provide all of the control operations of the control capabilities.

Example 43. The apparatus according to example 42, wherein the second node does not provide for use of a control interface between the second and third nodes.

Example 44. The apparatus according to example 41, wherein there are first, second, and third modes of the multiple modes, and wherein the sent indication indicates the second of the multiple modes and the configuring and using control operations of the control capabilities comprises configuring the second node to provide some of the control operations of the control capabilities, and wherein the first node is to provide others of the control operations of the control capabilities.

Example 45. The apparatus according to example 41, wherein there are first, second, and third modes of the multiple modes, and wherein the sent indication indicates the third of the multiple modes and the configuring and using control operations of the control capabilities comprises configuring the second node to provide all of the control operations of the control capabilities, and wherein the first node is to provide all of the control operations of the control capabilities.

Example 46. The apparatus according to any one of examples 44 or 45, wherein:
the second node uses, in the second mode and the third mode, a control interface between the second and third nodes for control operations.

Example 47. An apparatus, comprising means for performing:
in an open radio access network having a first node handling control plane operations in the open radio access network, a second node handling near-real-time control operations in the open radio access network, and a third node that provides wireless local area network termination for one or more access points, determining at a fourth node a policy affecting control plane distribution to be used between the first and second nodes, wherein the fourth node provides service management and orchestration in the open radio access network; and
sending, based on the policy, from the fourth node to the second node indication of control plane distribution to be used between the first and second nodes.

Example 48. The apparatus according to example 47, wherein the means are further configured to perform performing a policy change, and sending, based on the policy change, from the fourth node to the second node indication of a new control plane distribution to be used between the first and second nodes, the new control plane distribution replacing a current control plane distribution already in use.

Example 49. An apparatus, comprising means for performing:
in an open radio access network comprising a first node handling control plane operations and a second node handling near-real-time control operations, performing by a third node in the open radio access network a set up process between the third and second node to register the third node with the second node, the third node providing wireless local area network termination for access points; and
sending, from the third node to the second node, a message indicating any access points discovered and accessible by the third node.

Example 50. The apparatus according to example 49, wherein the means are further configured to perform receiving, at the third node from the second node, indication of interface configuration for an interface for control plane communications for the open radio access network, and setting configuration at the third node as to whether control plane communications are solely from the first node, partly from the first node and partly from the second node, or solely from the second node.

Example 51. The apparatus according to any one of examples 49 or 50, wherein the means are further configured to perform:
sending by the third node a status report to be ultimately received at the second node, the status report at least for one or more access points whose wireless local area network termination is provided by the third node;
receiving at the third node a request to release one or more flows for the user equipment that flow through the access point;
releasing by the third node the one or more flows.

Example 52. The apparatus according to any one of examples 49 or 50, wherein the means are further configured to perform:
receiving by the third node an addition request for a user equipment comprising indication of one or more flows to be added for the user equipment.

Example 53. The apparatus according to any one of examples 49 or 50, wherein the means are further configured to perform:
sending by the third node a status report to be ultimately received at a control entity controlling at least handover for user equipment between access points, the status report at least for one or more access points whose wireless local area network termination is provided by the third node and comprising indication of other access points whose wireless local area network termination is provided by the third node;
receiving at the third node a request to release one or more flows for the user equipment that flow through the access point;
releasing by the third node the one or more flows; and
sending a handover response from the third node to the control entity.

Example 54. The apparatus according to any one of examples 49 or 50, wherein the means are further configured to perform:
receiving by the third node an addition request for a user equipment comprising indication of one or more flows to be added for the user equipment, the addition request from a control entity controlling at least handover for user equipment between access points.

Example 55. An apparatus, comprising means for performing:
in an open radio access network comprising a first node handling control plane operations, a second node handling near-real-time control operations, and a third node providing wireless local area network termination for access points in the open radio access network, performing a set up process between the second and third node to register the third node with the second node, the third node; and
receiving, at the second node from the third node, a message indicating any access points discovered and accessible by the third node.

Example 56. The apparatus according to example 55, wherein the means are further configured to perform: sending, from the second node to the third node, indication of interface configuration for an interface for control plane communications for the open radio access network, and setting configuration at the second node as to whether control plane communications are solely from the first node, partly from the first node and partly from the second node, or solely from the second node.

Example 57. The apparatus according to any one of examples 55 to 56, wherein the means are further configured to perform: sending, by the second node to the first node, indication of the access points discovered and accessible by the third node and received in the message.

Example 58. The apparatus according to any one of examples 55 to 57, wherein the means are further configured to perform:
receiving, by the second node from the third node, a status report at least for one or more access points whose wireless local area network termination is provided by the third node;
performing a prediction indicating the third node should be changed for a user equipment to another node providing wireless local area network termination for access points, wherein the user equipment is connected to an access point whose wireless local area network termination is provided by the third node; and
sending, by the second node to the third node and in response to the prediction, a request to release one or more flows for the user equipment that flow through the access point.

Example 59. The apparatus according to example 58, wherein the means are further configured to perform:
sending, by the second node to the other node and in response to the prediction, an addition request for the user equipment comprising indication of one or more flows to be added for the user equipment.

Example 60. The apparatus according to any one of examples 55 to 57, wherein the means are further configured to perform:
receiving, at the second node from the third node, a status report for one or more access points whose wireless local area network termination is provided by the third node and comprising indication of other access points whose wireless local area network termination is provided by the third node;
performing a prediction indicating the third node should be changed for a user equipment to another node providing wireless local area network termination for access points, wherein the user equipment is connected to an access point whose wireless local area network termination is provided by the third nod; and
sending, from the second node to the third node, a request to release one or more flows for the user equipment that flow through the access point;
receiving, at the second node from the third node, a handover response indicating the one or more flows for the user equipment have been released.

Example 61. The apparatus according to example 60, wherein the means are further configured to perform:
sending, from the second node to the other node, an addition request for a user equipment comprising indication of one or more flows to be added for the user equipment.

Example 62. An apparatus, comprising means for performing:
in an open radio access network comprising a first node handling control plane operations, a second node handling near-real-time control operations, and a third node providing wireless local area network termination for access points in the open radio access network, receiving at the first node from the second node a message comprising indication of access points discovered and accessible by the third node;
performing a process between the first node and the third node second node to set up ab interface between the first and third nodes for control operations.

Example 63. The apparatus according to example 62, wherein the means are further configured to perform:
receiving information indicating a user equipment is to change from an original access point having its wireless local area network termination terminated by the third node to a new access point having its wireless local area network termination terminated by another node;
sending, from the first node to the other node, a request to add one or more flows for the user equipment that will flow through the new access point for the other node; and
sending, from the first node to the second node, a message indicating the one or more flows for the user equipment can be routed through the new access point and the one or more flows can be released from the original access point.

Example 64. The apparatus according to example 63, wherein the message indicating the one or more flows for the user equipment can be routed through the new access point and the one or more flows can be released from the original access point is part of a connection reconfiguration message, wherein the means are further configured to perform receiving a reconfiguration complete message by the first node, and sending, from the first node to the third node, a message indicating the one or more flows for the user equipment can be released from the original access point.

Example 65. The apparatus according to example 62, wherein the means are further configured to perform:
receiving information indicating a user equipment is to change from an original access point having its wireless local area network termination terminated by the third node to a new access point having its wireless local area network termination terminated by another node;
sending, from the first node to the other node, a request to add one or more flows for the user equipment that will flow through the new access point for the other node;
sending, from the first node to the third node, a message indicating the one or more flows for the user equipment can be released from the original access point;
sending, from the first node to the third node, a message requesting the one or more flows for the user equipment be handed over from the original access point to the new access point and corresponding other node;
receiving, at the first node from the third node, a response indicating a handover from the original access point to the new access point and corresponding other node is complete.

Example 66. The apparatus of any preceding apparatus example, wherein the means comprises:
at least one processor; and
at least one memory including computer program code, the at least one
memory and computer program code configured to, with the at least one processor,
cause the performance of the apparatus.

As used in this application, the term “circuitry” may refer to one or more or all of the following:
(a) hardware-only circuit implementations (such as implementations in only analog and/or digital circuitry) and
(b) combinations of hardware circuits and software, such as (as applicable) (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Embodiments herein may be implemented in software (executed by one or more processors), hardware (e.g., an application specific integrated circuit), or a combination of software and hardware. In an example embodiment, the software (e.g., application logic, an instruction set) is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted, e.g., in FIG. 2A. A computer-readable medium may comprise a computer-readable storage medium (e.g., memories 25 or other device) that may be any media or means that can contain, store, and/or transport the instructions for use by or in connection with an instruction execution system, apparatus, or device, such as a computer. A computer-readable storage medium does not comprise propagating signals.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

The following abbreviations that may be found in the specification and/or the drawing figures are defined as follows:

| | |
|---|---|
| 3GPP | 3rd Generation Partnership Project |
| 5G | fifth generation |
| 5GC | fifth generation core |
| AC | Access Controller |
| AI | Artificial Intelligence |
| AP | Access Point |
| AR | Augmented Reality |
| ATSSS | Access Traffic Steering, Switching & |
| | Splitting |
| ATSSS- | ATSSS-lower level |
| LL | |
| BSS | Basic Service Set |
| COTS | Commercial, Off the Shelf |
| CU | Central Unit |
| CU-CP | Central Unit - Control Plane |
| CU-UP | Central Unit - User Plane |
| DAS | Distributed Antenna System |
| DU | Distributed Unit |
| E2AP | E2 Application Protocol |
| E2SM- | E2 Service Model-Multi Access |
| MA | |
| E2SM- | E2 Service Model-Network Interface |
| NI | |
| eNB | eNodeB, an LTE base station |
| eLWA | Enhanced LTE-WLAN Aggregation |
| GRE | Generic Routing Encapsulation |
| IEEE | Institute of Electrical and Electronics |
| | Engineers |
| IoT | Internet of Things |
| IPsec | Internet Protocol secure |
| LBO | Local Breakout |
| LTE | Long Term Evolution |
| LWA | LTE-WLAN Aggregation |
| LWIP | LTE WLAN Radio Level Integration |
| | with IPSec Tunnel |
| MAM | Multi-Access Manager |
| MEC | Multi-Access Edge Computing |
| ML | Machine Learning |
| MPTCP | Multipath Transmission Control Protocol |
| N3IWF | Non-3GPP Interworking Function |
| Near-RT | Near Real-Time RAN Intelligent |
| RIC | Controller |
| NG-RAN | Next Generation- Radio Access Network |
| NG-WT | Next Generation Wireless Termination |
| NPN | Non-Public Network |
| NR | New Radio |
| O-CU | O-RAN Central Unit |
| O-CU-CP | O-RAN Central Unit Control Plane |
| O-CU-UP | O-RAN Central Unit User Plane |
| O-DU | O-RAN Distributed Unit |
| O-RAN | Open Radio Access Network |
| O-RU | O-RAN Radio Unit |
| QoE | Quality of Experience |
| QoS | Quality of Service |
| RAN | Radio Access Network |
| RIC | RAN Intelligent Controller |
| RRC | Radio Resource Control |
| RSSI | Received Signal Strength Indicator |
| RT | Real-Time |
| SMO | Service Management and Orchestration |
| STA | Station |
| TNGF | Trusted Non-3GPP Gateway Function |
| TWIF | Trusted WLAN Interworking Function |
| UE | User Equipment |
| UPF | User Plane Function |
| V2X | Vehicle to Everything |
| VR | Virtual Reality |
| VSAT | Very Small Aperture Terminal |
| WLAN | Wireless Local Area Network |
| WT | Wireless Termination |
| XnwAP | Xnw Application Protocol |

1. A method, comprising:
sending, by a first node handling control plane operations in an open radio access network to a second node handling near-real-time control operations in the open radio access network, one or more messages comprising indication of control capabilities exposed at the first node within context of multi-access operation between the first node, second node, and a third node that provides wireless local area network termination for one or more access points;
receiving, at the first node from the second node, an indication of one of multiple-access modes for multi-access operation; and
configuring which control operations of the control capabilities are able to be provided by the first node based on the received indication.

2. The method according to claim 1, wherein there are first, second, and third modes of the multiple modes, and wherein the received indication indicates the first of the multiple modes and the configuring and using control operations of the control capabilities comprises configuring the first node to provide all of the control operations of the control capabilities.

3. The method according to claim 1, wherein there are first, second, and third modes of the multiple modes, and wherein the received indication indicates the second of the multiple modes and the configuring and using control operations of the control capabilities comprises configuring the first node to provide some of the control operations of the control capabilities, and wherein the second node is to provide others of the control operations of the control capabilities.

4. The method according to claim 2, wherein:
the first node uses, in the first mode and the second mode, a control interface between the first and third nodes for control operations.

5. The method according to claim 1, wherein there are first, second, and third modes of the multiple modes, and wherein the received indication indicates the third of the multiple modes and the configuring and using control operations of the control capabilities comprises configuring the first node to provide none of the control operations of the control capabilities, and wherein the second node is to provide all of the control operations of the control capabilities.

6. The method according to claim 5, wherein:
the first node, in the third mode, does not provide for use of a control interface between the first and third nodes.

7. A method, comprising:
in an open radio access network having a first node handling control plane operations in the open radio access network, receiving at a second node one or more messages from the first node comprising indication of control capabilities exposed at the first node within context of multi-access operation between the first node, second node, and a third node that provides wireless local area network termination for one or more access points, the second node handling near-real-time control operations in the open radio access network;
sending, from the second node to the first node, an indication of one of multiple-access modes for multi-access operation; and
configuring and using control operations of the control capabilities that are able to be provided by the second node based on the sent indication.

8. The method according to claim 7, wherein there are first, second, and third modes of the multiple modes, and wherein the sent indication indicates the first of the multiple modes and the configuring and using control operations of the control capabilities comprises configuring the second node to provide none of the control operations of the control capabilities and wherein the first node is to provide all of the control operations of the control capabilities.

9. The method according to claim 8, wherein the second node does not provide for use of a control interface between the second and third nodes.

10. The method according to claim 7, wherein there are first, second, and third modes of the multiple modes, and wherein the sent indication indicates the second of the multiple modes and the configuring and using control operations of the control capabilities comprises configuring the second node to provide some of the control operations of the control capabilities, and wherein the first node is to provide others of the control operations of the control capabilities.

11. The method according to claim 7, wherein there are first, second, and third modes of the multiple modes, and wherein the sent indication indicates the third of the multiple modes and the configuring and using control operations of the control capabilities comprises configuring the second node to provide all of the control operations of the control capabilities, and wherein the first node is to provide all of the control operations of the control capabilities.

12. The method according to claim 10, wherein:
the second node uses, in the second mode and the third mode, a control interface between the second and third nodes for control operations.

13.-34. (canceled)

35. An first node handling control plane operations in an open radio access network, said first node, comprising:
at least one processor; and
at least one memory storing instructions that, when executed by the at least one processor, cause the first node to perform:
sending one or more messages to a second node handling near real time control operations in the open radio access network, said one of more messages comprising indication of control capabilities exposed at the first node within context of multi-access operation between the first node, second node, and a third node that provides wireless local area network termination for one or more access points;
receiving, from the second node, an indication of one of multiple-access modes for multi-access operation; and
configuring which control operations of the control capabilities are able to be provided by the first node based on the received indication.

36. The first node according to claim 35, wherein there are first, second, and third modes of the multiple modes, and wherein the received indication indicates the first of the multiple modes and the configuring and using control operations of the control capabilities comprises configuring the first node to provide all of the control operations of the control capabilities.

37. The first node according to claim 35, wherein there are first, second, and third modes of the multiple modes, and wherein the received indication indicates the second of the multiple modes and the configuring and using control operations of the control capabilities comprises configuring the first node to provide some of the control operations of the control capabilities, and wherein the second node is to provide others of the control operations of the control capabilities.

38. (canceled)

39. The first node according to claim 35, wherein there are first, second, and third modes of the multiple modes, and wherein the received indication indicates the third of the multiple modes and the configuring and using control operations of the control capabilities comprises configuring the first node to provide none of the control operations of the control capabilities, and wherein the second node is to provide all of the control operations of the control capabilities.

40. (canceled)

41. An second node, comprising:
at least one processor; and
at least one memory storing instructions that, when executed by the at least one processor, cause the second node to perform:
in an open radio access network having a first node handling control plane operations in the open radio access network, receiving one or more messages from the first node comprising indication of control capabilities exposed at the first node within context of multi-access operation between the first node, second node, and a third node that provides wireless local area network termination for one or more access points, the second node handling near-real-time control operations in the open radio access network;
sending, to the first node, an indication of one of multiple-access modes for multi-access operation; and
configuring and using control operations of the control capabilities that are able to be provided by the second node based on the sent indication.

42. The second node according to claim 41, wherein there are first, second, and third modes of the multiple modes, and wherein the sent indication indicates the first of the multiple modes and the configuring and using control operations of the control capabilities comprises configuring the second node to provide none of the control operations of the control capabilities and wherein the first node is to provide all of the control operations of the control capabilities.

43. (canceled)

44. The second node according to claim 41, wherein there are first, second, and third modes of the multiple modes, and wherein the sent indication indicates the second of the multiple modes and the configuring and using control operations of the control capabilities comprises configuring the second node to provide some of the control operations of the control capabilities, and wherein the first node is to provide others of the control operations of the control capabilities.

45. The second node according to claim 41, wherein there are first, second, and third modes of the multiple modes, and wherein the sent indication indicates the third of the multiple modes and the configuring and using control operations of the control capabilities comprises configuring the second node to provide all of the control operations of the control capabilities, and wherein the first node is to provide all of the control operations of the control capabilities.

46.-66. (canceled)
